(19) United States
(12) Patent Application Publication
(10) Pub. No.: US 2022/0101161 A1
(43) Pub. Date: Mar. 31, 2022

(54) PROBABILISTIC METHODS AND SYSTEMS FOR RESOLVING ANONYMOUS USER IDENTITIES BASED ON ARTIFICIAL INTELLIGENCE

(71) Applicant: LayerFive, Inc, Fremont, CA (US)

(72) Inventors: Sushil GOEL, Fremont, CA (US); Manziba Akanda NISHI, Richmond, VA (US)

(21) Appl. No.: 17/033,653

(22) Filed: Sep. 25, 2020

(51) Int. Cl. G06N 7/00

(52) U.S. Cl. CPC G06N 7/005

(57) ABSTRACT

Embodiments provide probabilistic methods, and systems for resolving user identity using artificial intelligence. The method performed by a processor includes receiving user interaction data associated with a user of a business interface. The method includes extracting user attributes from the user interaction data. The method includes determining candidate user profiles associated with a predefined location. The method includes predicting a likelihood of the user interaction data to be associated with a candidate user profile by performing steps: (1) applying machine learning models on each of the candidate user profiles to determine a matching probability score with the user interaction data; (2) identifying candidate user profile associated with matching probability score greater than a predefined threshold. The method also includes merging the user attributes from the user interaction data with the candidate user profile for generating a user profile. The method further includes assigning a user identifier for the user profile.

### TECHNICAL FIELD

The present disclosure relates to artificial intelligence based processing systems and methods and, more particularly to, cross-device probabilistic matching of user identities across multiple sessions by utilizing only first-party identity graphs and artificial intelligence techniques.

### BACKGROUND

In the present digital era, consumers are using multiple devices to interact with an enterprise. For example, a consumer may have a smartphone, a tablet, a work laptop, a personal laptop, a desktop and a smart Television (TV) and may choose to use any of these to access a website or a mobile application associated with the enterprise, or interact via other means, based on their convenience of time and place. While the consumers log in or provide credentials to the enterprise for interactions, but they interact anonymously for the majority of such interactions on the website or a mobile application supported by the enterprise. The enterprise needs to understand a consumer's context at every interaction to be able to anticipate the consumer needs, to make the interaction more meaningful, and to provide delightful consumer experience. Moreover, enterprises rely on accurate consumer profiles to deliver relevant content and/or marketing. However, most of these consumer interactions produce different identities that are completely unrelated, making it very difficult for a business to truly understand a consumer's context and deliver what's good for the consumer as well as profitable for the enterprise.

Traditionally, cookie data have been used to track and identify consumer preferences thereby enabling enterprises to personalize and serve contents that are not only relevant to the consumer needs, but also personally tailored for the consumer. For example, cookie data generated and used by web browsers, mobile applications and web service providers present a convenient approach to help identify a device and consumer's fragmented journey in the website across multiple sessions. However, the cookie as a consumer identifier is tied to a device or a browser. More specifically, if a consumer accesses a website on their desktop on one occasion and on their smartphone on another occasion, they will be recorded as two different visitors, rather than one, unless the consumer logs in or provides other identifying information on multiple devices. Moreover, third-party cookie data collected across multiple websites and mobile applications (e.g., social media applications) are used to understand consumer behavior of the consumer. However, such third-party cookie data collect vast amounts of data of a consumer across multiple enterprises (i.e., enterprise websites) which increases complexity of identity resolution and are not privacy safe.

In view of the above, there exists a need for a technical solution to resolve cross-device online identities of a consumer so as to improve the interaction context of the consumers and improve the efficiency of data management.

### SUMMARY

Various embodiments of the present disclosure provide systems, methods, electronic devices and computer program products for probabilistically resolving online identities to a user using artificial intelligence techniques.

In an embodiment, a computer-implemented method for probabilistically resolving user identity is disclosed. The computer-implemented method includes receiving, by a processor, user interaction data associated with a user of a business interface. The user interaction data is aggregated from one or more sources associated with the business interface. The computer-implemented method includes extracting, by the processor, a plurality of user attributes associated with the user from the user interaction data. The computer-implemented method includes determining, by the processor, one or more candidate user profiles associated with a predefined location among a plurality of user profiles. The predefined location is determined based at least on a location attribute of the plurality of user attributes. The computer-implemented method includes predicting, by processor, a likelihood of the user interaction data to be associated with at least one candidate user profile by performing steps: (1) applying, by the processor, one or more machine learning models on each of one or more candidate user profiles to determine a matching probability score with the user interaction data. The matching probability score is determined by mapping each user attribute of the plurality of user attributes to a corresponding user attribute in each of one or more user profiles; and (2) identifying, by the processor, at least one candidate user profile associated with matching probability score greater than a predefined threshold. The computer-implemented method also includes merging, by the processor, the plurality of user attributes from the user interaction data with a plurality of user attributes associated with at least one candidate user profile for generating a user profile. The computer-implemented method further includes assigning, by the processor, a user identifier for the user profile.

In another embodiment, an identity resolution system for probabilistically resolving user identities is disclosed. The identity resolution system includes a communication interface, a memory including executable instructions, and a processor communicably coupled to the communication interface. The processor is configured to execute the executable instructions to cause the identity resolution system to at least receive user interaction data associated with a user of a business interface. The user interaction data is aggregated from one or more sources associated with the business interface. The identity resolution system is further caused to extract a plurality of user attributes associated with the user from the user interaction data. The identity resolution system is further caused to determine one or more candidate user profiles associated with a predefined location among a plurality of user profiles. The predefined location is based at least on a location attribute of the plurality of user attributes. The identity resolution system is further caused to predict a likelihood of the user interaction data to be associated with at least one candidate user profile by performing steps: (1) apply one or more machine learning models on each of one or more candidate user profiles to determine a matching probability score with the user interaction data, wherein the matching probability score is determined by mapping each user attribute of the plurality of user attributes to a corresponding user attribute in each of one or more user profiles; and (2) identify at least one candidate user profile associated with matching probability score greater than a predefined threshold. The identity resolution system is also caused to merge the plurality of user attributes from the user interaction data with a plurality of user attributes associated with at least one candidate user profile for generating a user profile. The identity resolution system is further caused to assign a user identifier for the user profile.

In yet another embodiment, a computer-implemented method for probabilistically resolving user identities is disclosed. The computer-implemented method includes receiving, by a processor, user interaction data associated with a user of a business interface. The user interaction data is aggregated from one or more sources associated with the business interface. The computer-implemented method includes extracting, by the processor, a plurality of user attributes associated with the user from the user interaction data based at least in part on flexible metadata based mapping. The computer-implemented method includes determining, by the processor, one or more candidate user profiles associated with a predefined location among a plurality of user profiles. The predefined location is determined based at least on a location attribute of the plurality of user attributes. The computer-implemented method includes predicting, by processor, a likelihood of the user interaction data to be associated with at least one candidate user profile by performing steps: (1) applying, by the processor, one or more machine learning models on each of one or more candidate user profiles to determine a matching probability score with the user interaction data. The matching probability score is determined by mapping each user attribute of the plurality of user attributes to a corresponding user attribute in each of one or more user profiles; and (2) identifying, by the processor, at least one candidate user profile associated with matching probability score greater than a predefined threshold. The computer-implemented method also includes merging, by the processor, the plurality of user attributes from the user interaction data with a plurality of user attributes associated with at least one candidate user profile for generating a user profile. The computer-implemented method includes constructing an identity graph for the user profile based at least in part on the plurality of user attributes from the user interaction data and the plurality of user attributes associated with at least one candidate user profile. The computer-implemented method further includes assigning, by the processor, a user identifier for the user profile.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 is an example representation of an environment, in which at least some example embodiments of the present disclosure can be implemented;

FIG. 2A represents a sequence flow diagram of a process flow for resolving user identities during a training stage, in accordance with an example embodiment;

FIGS. 2B and 2C, collectively represent a sequence flow diagram of a process flow for resolving user identities during an evaluation stage, in accordance with an example embodiment

FIG. 3 is a simplified block diagram of an identity resolution system for resolving user identities, in accordance with one embodiment of the present disclosure;

FIG. 4A is a simplified block diagram representing training process of machine learning models for probabilistically resolving user identity, in accordance with an example embodiment;

FIG. 4B is a simplified block diagram representing evaluation process for probabilistically resolving user identity using machine learning models, in accordance with an example embodiment;

FIG. 5 is an example representation of an identity graph associated with user profile of a user, in accordance with an example embodiment;

FIG. 6 is an environment depicting an example of probabilistically resolving user identity, in accordance with an example embodiment;

FIG. 7 represents a flow diagram of a method for probabilistically resolving user identity, in accordance with an example embodiment;

FIG. 8 is a simplified block diagram of a server system for probabilistically resolving user identities, in accordance with an example embodiment; and

FIG. 9 is a simplified block diagram of a user device associated with a user capable of implementing at least some embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “identity resolution” or “resolving user identity” refers to a process of matching and linking user profiles from disparate sources to an individual or a user. In other words, anonymous identities across multiple devices and sessions are matched and associated with pre-existing user profiles based on machine learning techniques.

Moreover, the terms “user” and “consumer” have been interchangeably used throughout the description and refer to an individual accessing a business interface.

Overview

Various example embodiments of the present disclosure provide methods, systems, user devices, and computer program products for resolving online identities of an individual using machine learning techniques and merging information associated with the online identities into a single user profile.

In various example embodiments, the present disclosure describes an identity resolution system that probabilistically resolves user identities. The identity resolution system is configured to receive user interaction data associated with a user of a business interface. The user interaction data is aggregated from one or more sources associated with the business interface, such as, online sources and offline sources. The user interaction data include information aggregated from streaming data, batch data and Application Programming Interface (API) supported systems.

The identity resolution system is configured to extract a plurality of user attributes associated with the user from the user interaction data. In an embodiment, a flexible metadata based mapping is employed to identify data fields in the user interaction data and extract user attributes. The user attributes include but not limited to, user information (e.g., name, age, gender, nationality, e-mail identifier, registered user name, contact number and the like) and event attributes (e.g., cookie data, IP address, user's location, browser specifications, device identifiers, cart information, URLs and the like).

The identity resolution system is configured to deterministically match at least a set of user attributes associated with the user interaction data of the user with corresponding user attributes of at least one user profile of the plurality of user profiles based at least in part on a plurality of identity graphs. The set of user attributes includes user information (i.e., common identifiers) such as, registered name, date of birth, gender, contact number, address, and the like. An identity graph associated with a user profile of the plurality of user profiles and includes all known identifiers (e.g., registered name, contact number, user device identifiers, IP address, cookie data, MAIDs, e-mail identifiers, browser characteristics, URLs, transaction information) corresponding to the user aggregated over multiple devices and sessions. If a deterministic match is found, the user attributes from the user interaction data of the user are merged and updated in the corresponding user profile of the user.

In one embodiment, the identity resolution system is configured to determine one or more candidate user profiles associated with a predefined location among a plurality of user profiles. When the identity resolution system is unable to find a deterministic match, the identity resolution system identifies candidate user profiles within a geo-location boundary (i.e., predefined location) of the user. The predefined location is based at least on a location attribute among the plurality of user attributes.

In one embodiment, the identity resolution system is configured to predict a likelihood of the user interaction data to be associated with at least one candidate user profile. The identity resolution system is configured to apply one or more machine learning models on each of one or more candidate user profiles to determine a matching probability score with the user interaction data. The matching probability score is determined by mapping each user attribute of the plurality of user attributes to a corresponding user attribute in each of one or more candidate user profiles. In an embodiment, the matching probability score for a candidate user profile of one or more candidate user profiles is determined based at least in part on the temporal similarity measure and the device similarity measure associated with a candidate user profile.

The identity resolution system is configured to calculate a temporal similarity measure between the user interaction data and each of one or more candidate user profiles based at least in part on the mapping of a temporal data of the user interaction data with a corresponding temporal data associated with each of the candidate user profiles. Alternatively, the identity resolution system is configured to calculate a device similarity measure between the user interaction data and each of one or more candidate user profiles based at least in part on the mapping of an IP identifier of the user interaction data with an IP identifier associated with each of the candidate user profiles.

In an embodiment, the identity resolution system is configured to identify at least one candidate user profile associated with the matching probability score greater than a predefined threshold. The candidate user profile that is similar to the user interaction data is determined.

In an embodiment, the identity resolution system is configured to merge the plurality of user attributes from the user interaction data with a plurality of user attributes associated with at least one candidate user profile for generating a user profile. In other words, user interaction data of the user from different devices across multiple sessions are aggregated together in one user profile. In an embodiment, the identity resolution system is configured to assign a user identifier for the user profile.

Thereafter, the identity resolution system is configured to access an identity graph associated with the candidate user profile from one or more databases (e.g., a graph database). The identity graph associated with at least one candidate user profile is updated based at least in part on the plurality of user attributes associated with the user interaction data. The updated identity graph is stored in one or more databases.

During training, the identity resolution system is configured to access a positive sample and a negative sample. The positive sample includes one or more user interaction data of a user accessing the business interface from one or more user devices at different sessions. The user interaction data associated with the user are matched based on a deterministic matching of one or more user profiles. The negative sample includes one or more user interaction data selected randomly from the remaining user profiles of the plurality of user profiles.

In an embodiment, the identity resolution system is configured to extract the first set of features from the positive sample and the second set of features from the negative sample. The features (i.e., the first and the second set of features) are extracted using techniques such as, but not limited to, Term Frequency-Inverse Document Frequency (TF-IDF), count vectorizer, hash vectorizer for encoding the positive and negative samples. In an embodiment, the identity resolution system is configured to generate one or more machine learning models based at least in part on the first set of features and the second set of features. The first set of features and second set of features are provided to a supervised machine learning model that generates one or more machine learning models. The machine learning models learn to differentiate between the first set of features and the second set of features. More specifically, the machine learning models learn a decision boundary between the positive and negative samples to differentiate between user interaction data associated with one user from another user.

Without in any way limiting the scope, interpretation, or application of the claims appearing below, the technical effects of one or more of the example embodiments disclosed herein are to probabilistically resolve anonymous and unrelated online identities to an individual. Further, the present disclosure improves user experience of a user accessing a business interface across multiple user sessions from multiple devices.

The present disclosure utilizes machine learning techniques to probabilistically match anonymous users on a business interface to pre-existing user profiles in a privacy-compliant way such that users are provided with a more targeted and personalized experience. Additionally, the invention improves the ability of any business to understand the interaction context of its consumers and thereby improve the quality of content being delivered to the consumer. This aids in the efficient data management and makes business interactions more efficient, for example, an agent on service call understands the consumer better while interacting and attending to an issue. Moreover, by identifying anonymized user interactions, business organizations could identify potential frauds and save monetary and reputational damage.

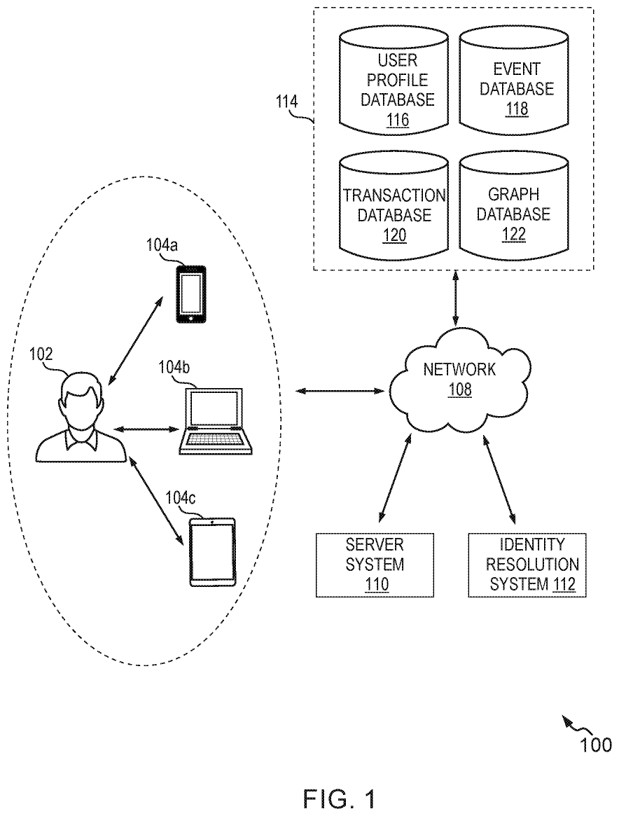

Various example embodiments of the present disclosure are described hereinafter with reference to FIGS. 1 to 9.

FIG. 1 illustrates an exemplary representation of an environment 100 related to at least some example embodiments of the present disclosure. Although the environment 100 is presented in one arrangement, other embodiments may include the parts of the environment 100 (or other parts) arranged otherwise depending on, for example, identity resolution, etc. The environment 100 generally includes a user 102, a server system 110, an identity resolution system 112 and one or more databases 114, each coupled to, and in communication with (and/or with access to) a network 108. The network 108 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among two or more of the parts or users illustrated in FIG. 1, or any combination thereof. Various entities in the environment 100 may connect to the network 108 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof.

For example, the network 108 may include multiple different networks, such as a private network made accessible by user devices 104a, 104b, 104c associated with the user 102, and a public network (e.g., the Internet etc.) through which the user 102 and the server system 110 or the identity resolution system 112 may communicate. In one embodiment, the user 102 may access each of his/her user devices 104a, 104b and 104c at different geographic locations and have similar browsing behavior on associated user devices 104a, 104b and 104c across multiple sessions.

The user 102 may access a business interface (i.e., e-commerce website interface) facilitated by a business on his/her respective user device (e.g., user device 104a) to browse products/services listed by the business. In an embodiment, the business interface (also referred to herein as ‘business application) is hosted and managed by the server system 110 associated with the business. The server system 110 provides an instance of the software application, referred to herein as the business interface (not shown) on receipt of a user request from a user device (e.g., user device 104a). The software application may be provided as a web application via a web browser on a user device (e.g., the user device 104b) or as a mobile application on a user device (e.g., the user device 104a). The user devices 104a, 104b, 104c may be any electronic device such as, but not limited to, a personal computer (PC), a tablet device, a Personal Digital Assistant (PDA), a voice activated assistant, a Virtual Reality (VR) device, a smartphone and a laptop.

The user 102 may have different user accounts to access the business interface via the user devices 104a, 104b, 104c separately. For example, a user account on the user device 104a will be different than the one on the user device 104b. Accordingly the server system 110 creates a user profile for storing user interactions when the user 102 accesses the business interface via the user device 104a and another user profile for user interactions when the user 102 accesses the business interface via the user device 104b.

In another example scenario, the user 102 may access the business interface on the user device 104a using credentials (i.e., registered/login information) and may be browsing the business interface anonymously via the user device 104b. Accordingly, the server system 110 creates two different user profiles for the user 102 in one or more databases 114. These two different user profiles are associated with same user (i.e., the user 102).

In an embodiment, the server system 110 sends a request to the identity resolution system 112 for resolving user identities of users accessing the business interface so as to understand an interaction context of each user (e.g., the user 102).

As described herein, the user profile may include, but not limited to, customer identifier (e.g., login credentials), device identifier (e.g., IP address), location information, browser information (e.g., cookie data, MAID), user records such as browsing behavior, and so forth.

In one embodiment, the user profile is aggregated across multiple sessions on different user devices (e.g., the user devices 104a. 104b and 104c). For instance, all browsing sessions of the user 102 on the business interface in which he identifies himself are aggregated and stored against his/her user profile. Alternatively, if the user 102 browses the business interface without any credentials (i.e., anonymously) a separate user profile is created for each session. In an embodiment, the server system 110 may request the identity resolution system 112 to determine a user profile that may match with this anonymous access from pre-existing user profiles.

The identity resolution system 112 is configured to perform one or more of the operations described herein. In general, the identity resolution system 112 is configured to probabilistically resolve anonymous identities to a user (e.g., the user 102) among a plurality of users of the business interface. In a more illustrative manner, the identity resolution system 112 provides a probabilistic matching technique for matching user profiles across multiple sessions and multiple devices. The identity resolution system 112 is a separate part of the environment 100, and may operate apart from (but still in communication with, for example, via the network 108) the server system 110, and any third party external servers to probabilistically resolve user identities on the business interface (and to access data to perform the various operations described herein). However, in other embodiments, the identity resolution system 112 may actually be incorporated, in whole or in part, into one or more parts of the environment 100, for example, the sever system 110. In addition, the identity resolution system 112 should be understood to be embodied in at least one computing device in communication with the network 108, which may be specifically configured, via executable instructions, to perform as described herein, and/or embodied in at least one non-transitory computer readable media.

The user (e.g., the user 102) may browse for goods/services on the business interface (e.g., mobile application) provided by the server system 110 via a user device (e.g., the user device 104a) during a specific time of day (i.e., evening time) from the comfort of his house for a session. The user 102 may have provided his credentials prior to starting the session. Accordingly, a user profile of the user 102 is created and stored in one or more databases 114. Subsequently, at work, the user 102 may use his work laptop (i.e., the user device 104b) to access the business interface (i.e., a web application) associated with the business to view goods/services similar to the ones he viewed via the user device 104a. In this example scenario, the user 102 may be accessing the business interface anonymously and a new user profile is created for this session. These two different user profiles essentially represent the same user (i.e., the user 102) and also share similar interaction context. The identity resolution system 112 is configured to associate/link these two different user profiles and provide a common user identity (also referred to as ‘unified user identifier’ or ‘user identifier’).

The environment 100 also includes one or more databases 114 communicatively coupled to the server system 110 and the identity resolution system 112 via the network 108. The one or more databases 114 include a user profile database 116, an event database 118, a transaction database 120, and a graph database 122. In one embodiment, one or more databases 114 may include multifarious data, for example, cookie data, location information, session information, social media data, Know Your Customer (KYC) data, page view information, cart information, transaction information, identity graphs.

The user profile database 116 stores user profile data associated with each user (e.g., the user 102) who accesses the business interface facilitated by the business. The user profile data may include user interaction data across multiple sessions such as, user identifiers, user device identifiers, user preferences, interests, location, browser information, device information and account identification information such as, first name, last name, age, gender, date of birth, location, registered e-mail identifier, social media information, contact number or the like.

The event database 118 includes a plurality of user interaction data (i.e., real-time user interactions) of a plurality of users (e.g., the user 102) from web interface and/or mobile interface of the user devices 104a, 104b, and 104c. In one embodiment, the event database 118 stores user interaction data during a session in form of event records. More specifically, every action (e.g., page view/product view/search string) by the user during a session on the business interface is stored as a distinct event record of the user 102.

The transaction database 120 stores real time transaction data of the plurality of users. The transaction data may include, but not limited to, call logs, chat logs and financial transaction information, such as past purchases in the past x days, transaction amount, and source of funds such as bank or credit cards, and the like.

The graph database 122 stores a plurality of identity graphs associated with a plurality of user profiles. The identity graphs essentially provide demographic, geographic, behavioral, purchase related and other crucial data about a user that help to improve interaction context of the business. The identity graph may include all identifiers associated with a consumer, for example, Personal Identifiable Information (PII) such as, such as e-mail identifiers, username, contact number and other digital and device identities such as, IP address, cookies, physical address, etc.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

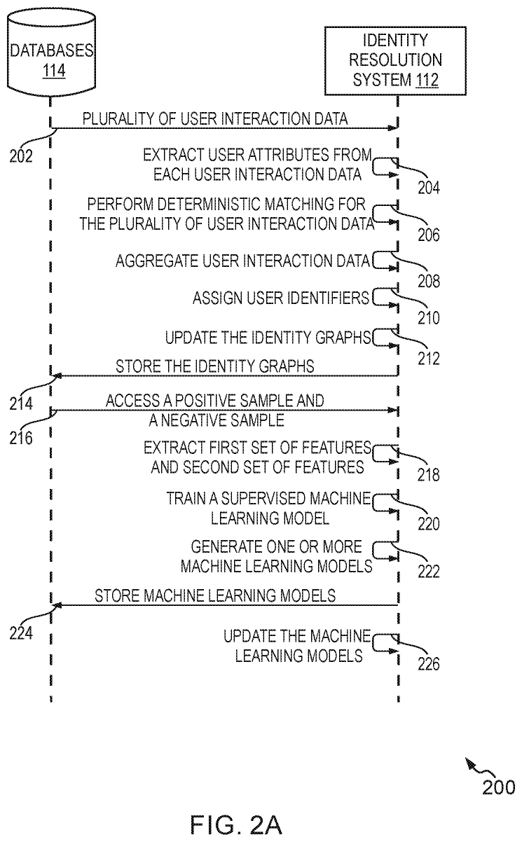

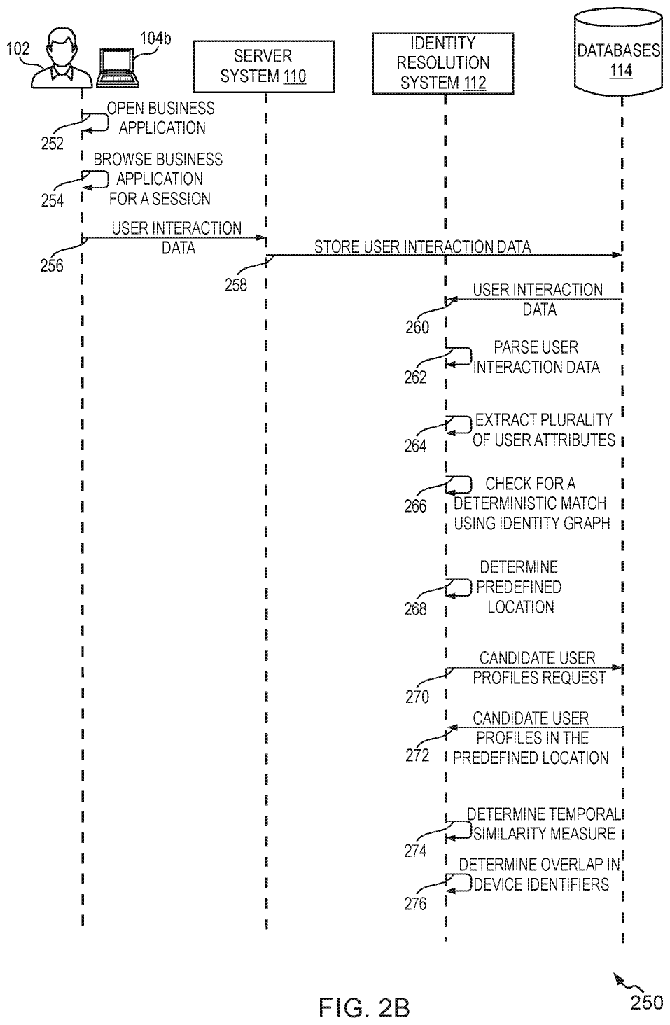

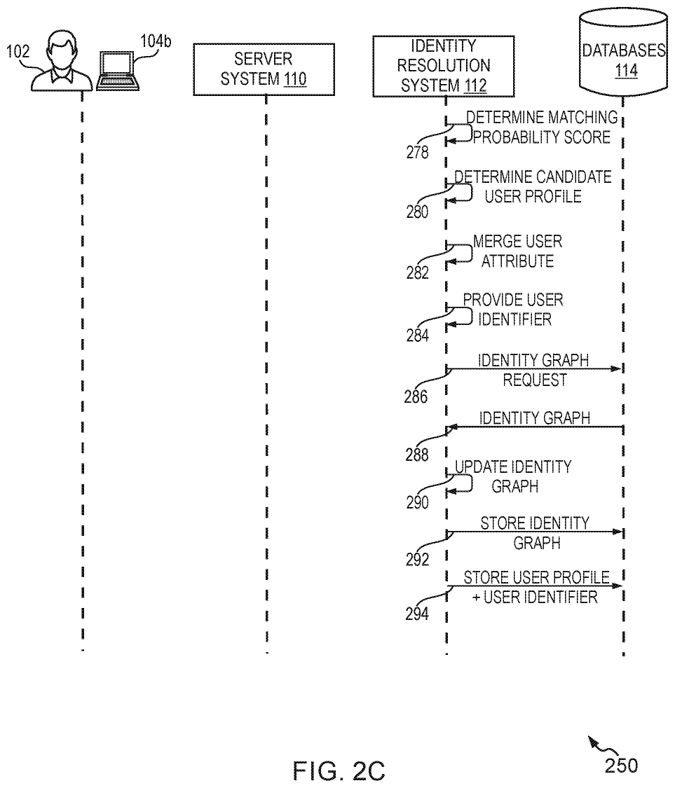

Some non-exhaustive example embodiments of resolving user identities of a user across multiple sessions and different user devices are described with reference to FIGS. 2A-2C to 9.

FIG. 2A represents a sequence flow diagram 200 of a process flow associated with resolving user identities during a training stage, in accordance with an example embodiment. The sequence of operations of the sequence flow diagram 200 may not be necessarily executed in the same order as they are presented. Further, one or more operations may be grouped together and performed in form of a single step, or one operation may have several sub-steps that may be performed in parallel or in sequential manner.

At 202, the identity resolution system 112 accesses a plurality of user interaction data from one or more databases 114 during a predefined interval. The plurality of user interaction data are associated with a plurality of users and are collected over particular time intervals (e.g. 4 hours). More specifically, a plurality of event records associated with each of the plurality of user interaction data is accessed from the event database 118. The event records include information such as, but not limited to, user information, URLs, search strings, cookie data, IP address, user's location, browser specifications, device identifiers, cart information or the like. For example, during a session, the user 102 may view 10-12 pages on a web interface. These page views generate 10-12 different events. The server system 110 creates an event record for each of these events (i.e., a different URL that the user 102 is visiting on the web interface) and stores each event record associated with the user 102 in the event database 118.

At 204, the identity resolution system 112 is configured to extract user attributes from each of the plurality of user interaction data. In an embodiment, the event records associated with a user interaction data are parsed based on a flexible metadata-based mapping. More specifically, the flexible metadata-based mapping is employed to identify data fields in the user interaction data that represent user information, event attributes, etc. After mapping, the identity resolution system 112 extracts the user attributes from the event records associated with the user interaction data. The user attributes include but not limited to, user information (e.g., name, age, gender, nationality, e-mail identifier, registered user name, contact number and the like) and event attributes (e.g., cookie data, IP address, user's location, browser specifications, device identifiers, cart information, URLs and the like).

At 206, the identity resolution system 112 is configured to perform a deterministic matching of the plurality of user interaction data with pre-existing user profiles based at least in part on a set of the user attributes associated with each of the plurality of user interaction data. Specifically, deterministic matching aims to identify one or more user interaction data from the plurality of user interaction data that may be from a user (e.g., the user 102) across different devices (e.g., the user devices 104a, 104b, and 104c) and multiple sessions based on common identifiers. In an embodiment, the set of user attributes includes user information (i.e., PII) among the plurality of user attributes. In other words, user information associated with different user interaction data are matched with pre-existing user profiles to identify if they are from the same user (e.g., the user 102). In an example scenario, the user 102 may be associated with a user profile (P) that was created when the user 102 signed up (i.e., provided credentials) to access the business interface via the user device 104a last evening (e.g., session S1). The user profile P includes user interaction data D1 (or event records associated with the user interaction data D1) from the session S1. Subsequently, the user 102 may provide credentials (e.g., registered name, e-mail identifier) and interact with the business interface via the user device 104b for a session (S2). Accordingly, the server system 110 may create a set of event records R1 for user interaction data (D2) in the session S2. The user interaction data (D1 and D2) from sessions S1 and S2 are essentially associated with the same user (e.g., the user 102) based on the credentials. The identity resolution system 112 employs a deterministic matching algorithm to identify such users across multiple devices and multiple sessions. More particularly, the deterministic matching algorithm searches through common identifiers (i.e., user information) associated with each user profile and links all user profiles that belong to the same physical person together. Typically, such user information are collected by all enterprises and include but not limited to first name, last name, e-mail identifier, date of birth, gender, and contact numbers.

At 208, the identity resolution system 112 is configured to aggregate plurality of user attributes associated with user interaction data with the pre-existing user profile based on the deterministic matching. The common identifiers being the same for the user interaction data D1, D2 at the session S1 and S2, the user interaction data (D1, D2) at the session S1 and S2 are grouped together. More specifically, the user attributes from the user interaction data (D1, D2) are aggregated into one user profile of the user 102.

At 210, the identity resolution system 112 is configured to assign user identifiers for the user profile. The user profile is identified by a unique identifier that is referred to as ‘user identifier’. The user profile is stored in the user profile database 116 with the user identifier.

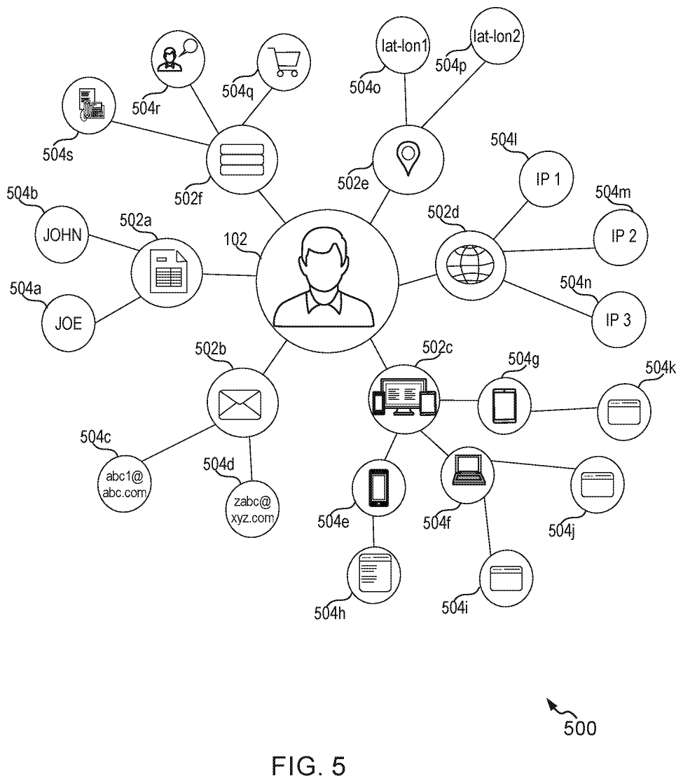

At 212, the identity resolution system 112 is configured to update identity graphs based on the deterministic matching of the plurality of user interaction data. Specifically, the identity graphs are updated based at least in part on the user profiles in the user profile database 116. An identity graph includes all known and anonymous identifiers corresponding to a user (e.g., the user 102). For example, an identity graph of the user 102 includes user information, user device information, user device identifiers, IP address, cookie data, MAIDs, e-mail identifiers, social handles, browser characteristics, URLs, transaction information among other details associated with the interaction of the user 102 on the business interface via user devices 104a, 104b, 104c across multiple sessions. In general, the identity graph of the user 102 includes user attributes from the user interaction data D1, and D2. An example of an identity graph is shown and explained with reference to FIG. 5.

At 214, the identity graphs are stored in one or more databases 114. In an embodiment, the identity graphs are stored in the graph database 122 with respective user identifiers.

At 216, the identity resolution system 112 is configured to access a positive sample and a negative sample from one or more databases 114. In general, a machine learning classifier requires these labeled data of positive and negative samples to learn a distinction between the positive and negative samples. The positive sample can be a pair of user interaction data from a same user (e.g., the user 102) while the negative sample would be a pair of user interaction data coming from different users (i.e., users other than the user 102). More particularly, the positive sample (i.e., a pair of user interaction data of the user 102) is selected from a user profile created based on a deterministic match. In other words, the positive sample may include a user interaction data D1 via user device 104a at session S1 and a user interaction data D2 via user device 104b at session S2. Negative samples are provided by arbitrarily selecting user interaction data from different users/user profiles without any deterministic match.

At 218, the identity resolution system 112 is configured to extract a first set of features and a second set of features from each of the positive sample and the negative sample, respectively. In an embodiment, a data pre-processing is performed on the positive and negative samples. This ensures that the user interaction data is cleaned to ensure there are no missing values, or corrupt records. The features (i.e., the first set of features and the second set of features) are extracted for encoding the set of positive and negative samples. Feature extraction is performed using techniques such as, but not limited to, Term Frequency-Inverse Document Frequency (TFIDF), count vectorizer, hashing vectorizer, one hot encoding vector and the like.

At 220, the identity resolution system 112 is configured to train a supervised machine learning model based on the first set of features and the second set of features. The features (i.e., the first and second set of features) extracted from the positive sample and negative sample are provided to a binary classifier to learn appropriate decision boundaries between the positive and negative samples. Examples of the binary classifier include but not limited to decision tree classifiers such as, Random Forest (RF), Gradient Boosting Trees, Gradient Boosting Machine (GBM), linear classifiers such as logistic regression, k-nearest neighbor, Naïve Bayes or non-linear classifiers such as the deep neural networks.

At 222, the identity resolution system 112 is configured to generate one or more machine learning models based on the learning from the positive sample and the negative sample. In an embodiment, one or more machine learning models are supervised machine learning models. At 224, the machine learning models are stored in one or more databases 114.

At 226, the identity resolution system 112 is configured to update the machine learning models. In an embodiment, the machine learning models may be trained and updated hourly or daily depending on business preference and confidence of the probabilistic match. In general, the model is trained on a plurality of samples (i.e., sets of positive and negative samples) to improve interaction context for every user.

FIGS. 2B and 2C, collectively represent a sequence flow diagram 250 of a process flow associated with resolving user identities during an evaluation stage is illustrated in accordance with an example embodiment. The sequence of operations of the sequence flow diagram 250 may not be necessarily executed in the same order as they are presented. Further, one or more operations may be grouped together and performed in form of a single step, or one operation may have several sub-steps that may be performed in parallel or in sequential manner.

At 252, the user 102 opens a business application associated with the server system 110 (or the business) on the user device 104a. The business interface may be a web application or mobile application. In an embodiment, the business interface may be downloaded from the server system 110 and installed on the user device 104a therein. The business interface may provision one or more user interfaces (UIs) based on user preferences.

At 254, the user 102 browses the business application for a session on the user device 104a. For instance, the user 102 may view products/services that may result 5-6 page views of the business interface.

At 256, the server system 110 is configured to collect user interaction data from one or more sources associated with the business interface. In an embodiment, the server system 110 ingests user interaction data from online and offline sources associated with the business interface. In other words, first-party data is accessed from the online and offline sources associated with the business interface. The user interaction data is aggregated from these sources and include streaming data, batch data and API (Application Programming Interface) supported system. Streaming data includes real-time data that is generated continuously and in small sizes. Streaming data includes a wide variety of data such as web events, app events, transactions, or geo-location information from connected devices. More specifically, they are log files generated by users/customers accessing mobile or web applications (e.g., the business interface). Batch data includes a group of user transaction data collected over a period of time for processing. Examples of batch data include but not limited to data collected from Customer Relationship Management (CRM) systems, call logs, chat logs, camp performance such as, e-mail identifier, search, social, display, etc. API systems include data obtained by API calls to another system, for example, Salesforce®, Zendesk®, Adobe®, Google®, Facebook®, etc

At 258, the server system 110 is configured to store the user interaction data in one or more databases 114. The user interaction data collected from sources (e.g., stream data, batch data, API supported systems) is appropriately processed and stored in one or more databases 114. In an example embodiment, the user interaction data is stored as event records in the event database 118. Specifically, the event records are extracted from data sources (i.e., stream data, batch data, and API supported system) and stored.

At 260, the identity resolution system 112 is configured to access the user interaction data. At 262, the identity resolution system 112 is configured to parse the user interaction data. At 264, the identity resolution system 112 is configured to extract a plurality of user attributes from the user interaction data. In an embodiment, the plurality of user attributes is extracted based on a flexible metadata-based mapping. The flexible metadata-based mapping identifies data fields in each structured data sequence (i.e., the user interaction data) that represents user information, event attributes, etc. In other words, after mapping, the plurality of user attributes in the user interaction data are extracted from the event records. The user attributes include but not limited to, user information (e.g., name, age, gender, nationality, e-mail identifier, registered user name, contact number and the like), and event attributes (e.g., cookie data, IP address, temporal data, user's location, browser specifications, device identifiers, usage characteristics, cart information, URLs and the like).

At 266, the identity resolution system 112 is configured to check for a deterministic match for the user interaction data based at least in part on a plurality of identity graphs in the graph database 122. As already explained, the identity graphs in the graph database 122 include a plurality of identifiers associated with each user (e.g., the user 102) of the plurality of users. During a deterministic matching, a set of attributes (i.e., the user information) is compared against the plurality of identity graphs to determine if the user interaction data is from a user associated with a pre-existing user profile. In an example, deterministic matching intends to identify if a registered user accesses the business interface with a new/different device (e.g., the user device 104c) by providing credentials that match with a pre-existing user profile. When a deterministic match is not determined for the user interaction data, step 268 is performed by the identity resolution system 112. In general, if the user 102 has been accessing the business interface anonymously via the user device 104c, then determining a deterministic match is not possible.

At 268, the identity resolution system 112 is configured to determine a predefined location based on the location attribute. In an embodiment, a predefined mathematical expression is used to determine the predefined location. For example, the predefined location (i.e. geo-location boundary) is defined by any location (lat/long) within a 50 mile radius of the location attribute (e.g., location of user device 104c) associated with the user 102.

At 270, the identity resolution system 112 is configured to request for candidate user profiles associated with the predefined location from one or more databases 114. Specifically, all candidate user profiles associated with the predefined location are identified in the user profile database 116

At 272, one or more databases 114 retrieve one or more candidate user profiles associated with the predefined location and send the candidate user profiles to the identity resolution system. In an example, all possible zip codes that are within a defined radius (i.e., the predefined location) of a given zip code are identified. Thereafter, candidate user profiles associated with the possible zip codes are retrieved.

At 274, the identity resolution system 112 is configured to determine a temporal similarity measure for each of the candidate user profiles with the user interaction data. More specifically, the temporal data (i.e., user attribute) of the user 102 associated with user interaction data is compared against a corresponding user attribute (i.e., temporal data) of each of the candidate user profiles from the user profile database 116. In general, a day/time at which a user interacts (i.e., accesses) with the business interface is observed from a specific user device/browser and follows a fixed set of patterns. For instance, certain users (e.g., the user 102) might be available on certain devices (e.g., the user device 104a) at fixed time of the day or day of the week. In an example scenario, the temporal data (also referred to as ‘usage attribute’) of the user 102 depicts that he/she used the user device 104b to access the business interface on a weekday (e.g., Tuesday) between 10:00 AM-11:00 AM. Assuming, the candidate user profile has usage attributes indicating the business interface is commonly accessed by a user between 5:00 PM-6:00 PM on an associated user device, and then temporal similarity measure is usually low indicating the user interaction data from the user 102 is necessarily not associated with the candidate user profile.

At 276, the identity resolution system 112 is configured to determine a device similarity measure based at least on an overlap in device identifiers of each of the candidate user profiles with the user interaction data. The device identifier refers to IP address of the user device (e.g., the user device 104a) that the user 102 may use to access/interact with the business interface. In general, the device similarity is used to determine a distance measure between IP address of the user device 104a associated with the user interaction data and IP address or IP addresses associated with a candidate user profile. The device similarity (i.e., the distance measure between the two servers) can be determined using any statistical measure to identify how close two IP distributions are. An example of the statistical metric is Bhattacharya distance. The overlap of IP address is usually based on a common intuition that a user would normally be browsing the business interface using a certain device from a fixed set of IP addresses with some occasional exceptions and the likelihood of an overlap between different users would be very low. For example, the IP address of the user device 104b of the user 102 may usually be same/similar when connecting via a home router to a home network to access the business interface. In other words, for the same user (e.g., the user 102), there would exist an overlap between the IP distributions that can be leveraged to distinguish user interaction data of the user 102 from other user interaction data associated with another user.

At 278, the identity resolution system 112 is configured to determine a matching probability score for each of the candidate user profiles with the user interaction data. In an embodiment, the machine learning models generated during a training phase are used to determine the matching probability score. In other words, the machine learning models are employed to predict a likelihood of the user interaction data of the user 102 to be associated with one of the candidate user profiles. In an embodiment, the matching probability score is determined based at least on the temporal similarity measure and the device similarity measure between the user interaction data and a candidate user profile using the machine learning models. A weight may be provided for each of these measures (i.e., temporal similarity measure and device similarity measure) to determine the matching probability score. The weight can be adjusted to provide a higher say to one of the measures (e.g., temporal similarity measure/device similarity measure) based on a confidence measure.

At 280, the identity resolution system 112 is configured to determine a candidate user profile that is similar to the user interaction data based on a probabilistic matching. In an embodiment, a candidate user profile with matching probability greater than a pre-defined threshold is identified as a probabilistic match for the user interaction data. In other words, the anonymous user interacting with the business interface is identified as being associated with an already existing user profile.

At 282, the identity resolution system 112 is configured to merge the user attributes of the user interaction data with user attributes of the candidate user profile. In other words, event records from the user interaction data are updated in the candidate user profile on probabilistically determining that the interaction (i.e., the user interaction data) is from the user 102 associated with the candidate user profile. Specifically, user attributes from the user interaction data such as, cookie data, device identifier, customer identifier, e-mail addresses, transaction information, and the like extracted from the user interaction data are added to the candidate user profile along with pre-existing attributes and/or user interaction data to generate a merged user profile (i.e., a new user profile).

At 284, the identity resolution system 112 is configured to provide a user identifier for the merged user profile. In general, each of the user profiles has a unique identifier for identifying the user (e.g., the user 102). Assuming, user identifier I1 of the user profile P1 (i.e., candidate user profile) as an individual ID and user identifier I2 of the user profile P2 (i.e., user profile associated with the user interaction data) as another individual ID, the user identifiers (I1 and I2) are replaced by a unified consumer ID (also referred to as ‘a user identifier’). In other words, the identity resolution system 112 provides a new/unique identifier for the user profile that includes user interaction data from the user profiles P1 and P2. Accordingly, the merged user profile of the user 102 includes user attributes of the user 102 aggregated across multiple devices and sessions.

At 286, the identity resolution system 112 is configured to send an identity graph request to one or more databases 114. Specifically, the identity graph associated with the candidate user profile is accessed from the graph database 122.

At 288, the identity resolution system 112 receives the identity graph from one or more databases 114 (i.e., the graph database 122).

At 290, the identity resolution system 112 is configured to update the identity graph associated with the candidate user profile based on the merged user profile. In other words, the user attributes extracted from the user interaction data that probabilistically match with the pre-existing user profile (i.e., candidate user profile) are updated in the identity graph associated with the candidate user profile.

At 292, the updated identity graph is stored in one or more databases 114. In an embodiment, the updated identity graph is stored in the graph database 122 with the unified user identifier.

At 294, the identity resolution system 112 stores the user profile (i.e., the merged user profile) along with the user identifier in one or more databases 114 (e.g., the user profile database 116).

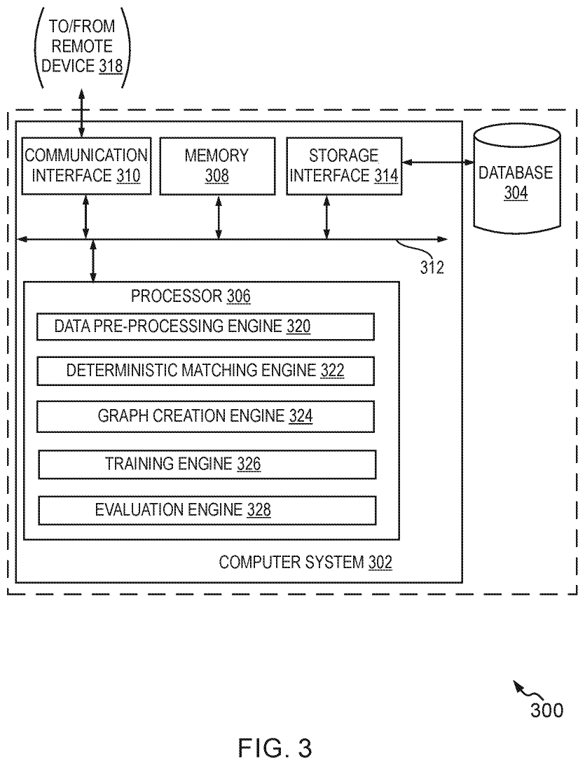

Referring now to FIG. 3, a simplified block diagram of an identity resolution system 300 is illustrated in accordance with an embodiment of the present disclosure, is shown. The identity resolution system 300 is similar to the identity resolution system 112. In some embodiments, the identity resolution system 300 is embodied as a cloud-based and/or SaaS-based (software as a service) architecture. In one embodiment, the identity resolution system 300 is integrated within the server system 110.

The identity resolution system 300 includes a computer system 302 and a database 304. The computer system 302 includes at least one processor 306 for executing instructions, a memory 308, a communication interface 310 and a storage interface 314 that communicate with each other via a bus 312.

In some embodiments, the database 304 is integrated within the computer system 302. For example, the computer system 302 may include one or more hard disk drives as the database 304. The storage interface 314 is any component capable of providing the processor 306 with access to the database 304. The storage interface 314 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 306 with access to the database 304.

In one embodiment, the database 304 is configured to store one or more machine learning models such as, likelihood prediction models for determining if a user interaction data is associated with a user profile. During a training process, the processor 306 includes suitable logic, circuitry, and/or interfaces to execute operations for receiving a plurality of user interaction data from a plurality of users for learning a decision boundary between user interaction data of one user and another user. The processor 306 also receives a user interaction data that needs to be classified/associated with a pre-existing user profile during an evaluation phase.

Examples of the processor 306 include, but are not limited to, an application-specific integrated circuit (ASIC) processor, a reduced instruction set computing (RISC) processor, a complex instruction set computing (CISC) processor, a field-programmable gate array (FPGA), and the like. The memory 308 includes suitable logic, circuitry, and/or interfaces to store a set of computer readable instructions for performing operations. Examples of the memory 308 include a random-access memory (RAM), a read-only memory (ROM), a removable storage drive, a hard disk drive (HDD), and the like. It will be apparent to a person skilled in the art that the scope of the disclosure is not limited to realizing the memory 308 in the identity resolution system 300, as described herein. In another embodiment, the memory 308 may be realized in the form of a database server or a cloud storage working in conjunction with the identity resolution system 300, without departing from the scope of the present disclosure.

The processor 306 is operatively coupled to the communication interface 310 such that the processor 306 is capable of communicating with a remote device 318 such as, user devices 104a, 104b, 104c including the business interface, the server system 110, or communicate with any entity connected to the network 108 (as shown in FIG. 1).

It is noted that the identity resolution system 300 as illustrated and hereinafter described is merely illustrative of an apparatus that could benefit from embodiments of the present disclosure and, therefore, should not be taken to limit the scope of the present disclosure. It is noted that the identity resolution system 300 may include fewer or more components than those depicted in FIG. 3.

In one embodiment, the processor 306 includes a data pre-processing engine 320, a deterministic matching engine 322, a graph creation engine 324, a training engine 326 and an evaluation engine 328. It should be noted that components, described herein, such as the training engine 326, and the evaluation engine 328 can be configured in a variety of ways, including electronic circuitries, digital arithmetic and logic blocks, and memory systems in combination with software, firmware, and embedded technologies. It is noted that the identity resolution system 300 as illustrated and hereinafter described is merely illustrative of an apparatus that could benefit from embodiments of the present disclosure and, therefore, should not be taken to limit the scope of the present disclosure. It is noted that the identity resolution system 300 may include fewer or more components than those depicted in FIG. 3.

The data pre-processing engine 320 includes suitable logic and/or interfaces for analyzing the plurality of user interaction data associated with interactions performed by the plurality of users on the business interface. The data pre-processing engine 320 accesses the plurality of user interaction data stored in one or more databases 114. The user interaction data in one or more databases 114 include first-party data that are accessed from different sources (i.e., online sources, offline sources) associated with the business interface. The user interaction data includes streaming data, batch data and data from API supported systems. Online sources include information sourced from the web application or mobile application associated with the business interface installed on the user device (e.g., the user device 104a) of the user 102 and offline sources include user records collected in batch mode, for example, CRM record, transaction records, etc. It shall be noted that the term ‘user interaction data’ includes user interaction on a business interface aggregated from the different sources. More specifically, the user interaction data includes event records of a user interacting with the business interface during a session. For example, every event (e.g., product view, transaction, search) on the business interface during the session is tracked and stored separately as event records.

In an embodiment, a user profile is created in one or more databases 114 (e.g., the user profile database 116) for the user interaction data of a user (e.g., the user 102) during a session. The user profile is identified by a user identifier that may include but not limited to numbers, alphabets, special characters or any combination of the above.

Each event record in the user interaction data is parsed into a corresponding structured data sequence based on flexible metadata-based mapping. The flexible metadata-based mapping identifies data fields in each structured data sequence (i.e., the user interaction data) that represents interaction attributes associated with the user 102 for a session. More specifically, event records of the user interaction data include user specific information and are parsed to extract tokens.

The deterministic matching engine 322 includes suitable logic and/or interfaces for matching a user interaction data with a similar user interaction data (or user profile). After mapping, a plurality of user attributes are extracted from the event records associated with the user interaction data. The user attributes include but not limited to, user information (e.g., name, age, gender, nationality, e-mail identifier, registered user name, contact number and the like) and event attributes (e.g., cookie data, IP address, geo-location of the user, browser specifications, device identifiers, usage characteristics such as, user behavior, cart information, URLs, transaction information such as, payment history, call logs, chat logs and the like).

In an embodiment, the deterministic matching engine 322 is configured to perform a deterministic matching of the plurality of user interaction data with pre-existing user profiles based at least in part on a set of the user attributes associated with each of the plurality of user interaction data. The set of attributes include common identifiers of the user interaction data. Specifically, deterministic matching aims to identify one or more user interaction data from the plurality of user interaction data that may be from a user (e.g., the user 102) across different devices (e.g., the user devices 104a, 104b, and 104c) and multiple sessions. Accordingly, deterministic matching compares common identifiers (i.e., user information), for example, registered name, e-mail identifier, gender, address in a user interaction data with remaining user interaction data to determine a deterministic similarity with pre-existing user profiles. For example, user information from a user interaction data (D1) is compared with corresponding user information in pre-existing user profiles (P1, P2, P3) to determine a deterministic similarity with each of the user profiles P1, P2, P3. As an example, the user interaction data D1 may correspond to a session when the user 102 accessed the business interface via the user device 104b and the user interaction data in the pre-existing user profile P3 depicts a session when the user 102 browsed products/services on the business interface via the user device 104c. Assuming, the user 102 provided credentials for accessing the business interface using user device 104b, the deterministic similarity between the user interaction data D1 and the user profile P3 based on matching user information is high. The user interaction data D1 is essentially associated with the same user (e.g., the user 102) although he has used different devices (e.g., the user devices 104b, 104c) to access the business interface.

The deterministic matching engine 322 is configured to merge user interaction data with a pre-existing user profile when a deterministic similarity between the common identifiers of the user interaction data and the pre-existing user profile is greater than a deterministic threshold. In other words, the user attributes associated with the user interaction data are aggregated along with the user attributes of the pre-existing user profile of the user 102 to generate a new user profile for the user 102 (also referred to hereinafter as ‘user profile’).

In an embodiment, the user profile (i.e., the new user profile) that includes aggregated information from the user interaction data and the pre-existing user profile is provided a user identifier. Specifically, the merged user profile that includes user attributes across multiple sessions and different devices for the same user (e.g., the user 102) are given a unified user identifier. For example, if the pre-existing user profile P3 is associated with a consumer identifier (e.g., P #123) and if the user interaction data D1 is associated with another consumer identifier (e.g., C #123), the new user profile is provided a unified user identifier (e.g., I #543).

The graph creation engine 324 includes suitable logic and/or interfaces for creating a plurality of identity graphs for the plurality of user profiles in the user profile database 116. Each user profile is associated with an identity graph of the plurality of identity graphs. In an embodiment, an identity graph for a user is created based at least in part on the plurality of user attributes associated with the user profile of a user. In general, the identity graph includes all identifiers of the user 102, for example, user device information, browser information, cookie data, e-mail identifiers, IP addresses, geo-locations of the user devices, transaction information (e.g., past purchases, payment mode, payment card information), and the like. More specifically, identity graphs contain privacy-compliant user information, demographic and behavior information describing the individuals (i.e., the plurality of users) in the database.

The structure of the identity graphs are flexible and allow linking and updating user attributes from a new or anonymous user interaction data based on matching (i.e., deterministic or probabilistic matching) with a pre-existing user profile. For instance, the identity graph contains heterogeneous information (e.g., different user devices, user interaction data from multiple sessions, interaction events, etc.) of a single entity (i.e., the user 102) that changes with time. In an example, when a user interaction data associated with an anonymous interaction resulting in attributes A2 is matched (i.e., deterministically or probabilistically) with the user 102, the identity graph of the user 102 already including attributes A1 is updated with the attributes A2.

In one example scenario, the user 102 accesses the business interface using user devices 104a, 104b, and 104c. Specifically, the user 102 may use a particular browser on each of the user devices (e.g., Google Chrome® on the user device 104b and Safari® on the user device 104c) and an optimized version of the business interface on the user device 104a. Moreover, the user 102 may be associated with MAID M1, cookie data C1, C2 that are collected from the browsers on respective user devices 104b, 104c, 104a, respectively. In the above example scenario, the identity graph has a node depicting the user 102 (i.e., root node) and a plurality of parent nodes depicting a plurality of user attributes, for example, user devices, browser information, cookie data and the like. The plurality of user attributes (i.e., the parent nodes) take up different variables (shown as leaf nodes in FIG. 5) based on the user attributes determined form one or more user interaction data associated with the user. An example of an identity graph is shown and explained with reference to FIG. 5.

The training engine 326 includes suitable logic and/or interfaces for generating one or more machine learning models that determine a likelihood of a user interaction data to be associated with a pre-existing user profile (i.e., the user 102). In other words, the machine learning models learn to classify a user interaction data with a pre-existing user profile based at least in part on the plurality of attributes.

In an embodiment, a supervised machine learning model is trained to predict the likelihood of the user interaction data to be associated with a user. More specifically, the supervised machine learning model is trained to probabilistically match the user interaction data to a pre-existing user profile. In general, a machine learning classifier (i.e., the machine learning model) requires a labeled data of positive and negative samples to learn a distinction between the positive and negative samples. This distinction pattern (i.e., the decision boundary) is used by the machine learning model to predict the likelihood of the user interaction data to be associated with a user profile. The positive samples include user interaction data from a same user (e.g., the user 102) while the negative samples include user interaction data coming from different users (i.e., users other than the user 102). More particularly, the positive sample (i.e., a pair of user interaction data of the user 102) is selected from a user profile created based on a deterministic match. In an embodiment, the training engine 326 accesses a positive sample and a negative sample from one or more databases 114 to learn the decision boundary between the positive and negative samples. It shall be noted that a plurality of positive samples and corresponding negative samples may be used to iteratively train the supervised machine learning model.

In an embodiment, the training engine 326 is configured to extract a first set of features and a second set of features from the positive samples and the negative samples, respectively. In other words, the positive and negative samples are encoded for training the supervised machine learning model. Techniques such as, but not limited to, Term Frequency-Inverse Document Frequency (TF-IDF), count vectorizer for determining word counts, hash vectorizer for hashing hashing words and converting them to vectors can be used for encoding the positive and negative samples (user interaction data).

The TF-IDF determines word frequency to highlight/indicate words that are more frequent in a user interaction data (i.e., positive sample/negative sample) but not across all user interaction data. More particularly, the TF-IDF technique is used to determine word frequency in tokens that are extracted from URLs. The count vectorizer is used to provide an encoded vector for a list of IP addresses. The encoded vector includes a length of an entire vocabulary (i.e., a total number of IP addresses in a positive/negative sample) and an integer count indicating a number of times an IP appears in the user interaction data (i.e., the positive/negative sample). The user attributes such as, device, Operating system (OS), browser name, user device are passed through a labeled indexer to generate an encoded vector corresponding to the labeled index for these categorical values. The features (i.e., the first and second set of features) are encoded as arrays based on the user attributes of the positive and negative sample using encoding techniques.

The scores/values in the array are normalized to values between 0 and 1 and these encoded vectors (i.e., the first and the second set of features) are provided to the supervised machine learning model. Examples of the supervised machine learning model that learns a binary classification between the positive and negative samples include but not limited to, decision tree classifiers such as, Random Forest (RF), Gradient Boosting Trees, Gradient Boosting Machine (GBM), linear classifiers such as logistic regression, k-nearest neighbor, Naïve Bayes or non-linear classifiers such as the deep neural networks.

In an embodiment, one or more machine learning models are generated based on the positive and negative samples provided during the training phase. The machine learning models are stored in one or more databases 114. The frequency in which these machine learning models are trained and updated in one or more databases can be fixed to hourly or daily depending on the application need and confidence of the probabilistic match during evaluation phase.

The evaluation engine 328 includes suitable logic and/or interfaces for predicting a likelihood of the user interaction data to be associated with at least one candidate user profile of one or more candidate user profiles based at least in part on the machine learning models during the evaluation phase. The candidate user profiles are identified from a predefined location. The predefined location is a geo-location boundary configured based on mathematical expression and includes locations (e.g., 20 mile radius) surrounding a geo-location (i.e., location attribute) of a user associated with the user interaction data.

The evaluation engine 328 is configured to determine a temporal similarity measure for each of the candidate user profiles with the user interaction data. The temporal similarity measure indicates behavioral similarity in user interaction between the candidate user profile and the anonymous interaction. For instance, temporal data (i.e., usage characteristics) such as, time of interaction, day of interaction, user device used for interaction with the business interaction of the anonymous interaction are compared against each of the candidate user profiles to determine a temporal similarity of the anonymous interaction with each of the candidate user profiles. In general, a day/time at which a user interacts (i.e., access) with the business interface is observed from a specific user device/browser and follows a fixed set of patterns that is compared against patterns associated with each of the candidate user profiles to determine temporal similarity measures.

In an embodiment, the evaluation engine 328 is configured to determine a device similarity measure based at least on an overlap in device identifiers (i.e., IP addresses) of each of the candidate user profiles with the user interaction data. In general, the device similarity is used to determine a distance measure between IP address of a user device associated with the anonymous user interaction and IP address or IP addresses associated with a candidate user profile. The device similarity can be determined using any statistical metric to identify how close two IP distributions are.

The evaluation engine 328 is configured to determine a matching probability score for each of the candidate user profiles with the user interaction data. In an embodiment, one or more machine learning models are applied on the candidate user profiles to determine the matching probability score. In other words, the machine learning models are employed to predict a likelihood of the user interaction data of the user 102 to be associated with one of the candidate user profiles based on the temporal similarity measure and the device similarity measure. In an embodiment, the evaluation engine 328 is configured to determine at least one candidate user profile with a matching probability score greater than a threshold score. More specifically, the anonymous user interaction is probabilistically matched with the candidate user profile with matching probability score greater than the threshold score. In other words, the machine learning model trained on the user attributes predicts that there is a high likelihood that the anonymous interaction from a user device (e.g., smartphone) of a user is the same person who logged in earlier using his/her laptop based on the temporal and device similarity measure between the user interactions of the user.

In an embodiment, the evaluation engine 328 is configured to provide a unified user identifier (i.e., the user identifier) for the anonymous interaction. The unified user identifier is usually a new user identifier that replaces a user identifier of the candidate user profile and user identifier associated with the anonymous interaction. More specifically, the user attributes of the candidate user profile and the anonymous interaction are merged together. Additionally, the identity graph of the candidate user profile is also updated based on the user attributes from the anonymous interaction. This new user profile is provided the unified user identifier after merging the user attributes associated with both the user identifiers.

During the evaluation phase, the evaluation engine 328 on receiving a new user interaction data (i.e., an anonymous interaction) with a new user identifier, tries to deterministically match the user interaction data with a pre-existing user profile. For example, if the user interaction data includes a new cookie data (e.g., login identifier, customer identifier) from the anonymous interaction, the evaluation engine 328 tries to find a deterministic match with any pre-existing user profile based on the plurality of identity graphs in the graph database 122.

However, if a deterministic match with a pre-existing user profile is not found for the anonymous interaction, the evaluation engine 328 creates a new user profile (i.e., an anonymous user profile) with an associated user identifier and appends the plurality of attributes extracted from the anonymous interaction. Accordingly, an identity graph is created for the anonymous user profile based on the plurality of attributes associated with the anonymous interaction.

The evaluation engine 328 employs probabilistic matching using the trained machine learning models for matching anonymous user profiles with candidate user profiles. Specifically, the evaluation engine 328 provides user attributes from the anonymous interaction such as, IP address, browser characteristics, browsing behavior, geo-location, time etc. to a probabilistic matching algorithm. The probabilistic matching checks the user attributes against all the known users (i.e., user profiles) and their related user attributes (i.e., user interaction data) for the past “n” number of days received from a specified radius (i.e., predefined location) near to the location of the user associated with the anonymous interaction. If probabilistic matching system finds a candidate user profile with enough confidence (i.e., greater than the matching probability score), then the user attributes of the anonymous interaction (i.e., newly created user profile) are associated with the candidate user profile (i.e., pre-existing user profile).

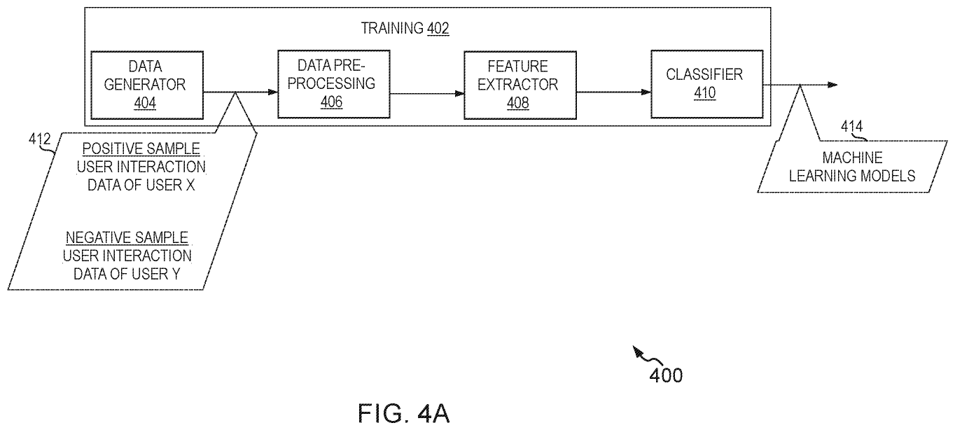

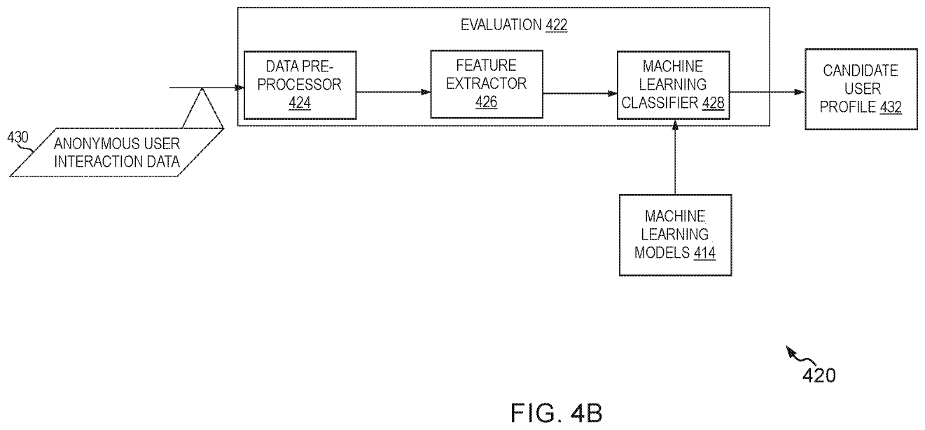

Referring now to FIG. 4A, a simplified block diagram 400 representing training process of machine learning models for probabilistically resolving user identity is illustrated in accordance with an example embodiment. In an embodiment, a supervised machine learning model is trained for determining a likelihood of an anonymous interaction to be associated with a pre-existing user profile of a user (see, 402).

At first, the processor 306 is configured to generate data that is used for training the supervised machine learning model (see, 404). In general, a positive sample and a negative sample (see, Table 412) are provided to machine learning classifier (i.e., the supervised machine learning model) that learns a decision boundary between the positive samples and the negative samples. The positive sample includes one or more user interaction data from a user X (e.g., the user 102) and corresponding negative sample includes user interaction data selected arbitrarily/randomly from other users in one or more databases 114 (e.g., a user Y). During data pre-processing, the positive and negative samples are cleaned to ensure there are no missing values, or corrupt records (see, 406). Specifically, a flexible metadata based mapping is performed to standardize and normalize the positive and negative samples. In one example, the samples (i.e., the positive and negative samples) are parsed to extract words/tokens from the user interaction data.

In an embodiment, features are extracted from the positive and negative samples for training the supervised machine learning model (see, 408). In other words, the positive and negative samples are encoded as integers or floating point values for use as input to the supervised machine learning model. In one example, to vectorize the positive and negative samples, encoding techniques such as, count vectorizer, TF-IDF, hashing vectorizer are used. The processor 306 is configured to provide the extracted features to a classifier to generate machine learning models (see, 410). The machine learning models (see, 414) trained on the samples (i.e., the positive and negative samples) learn appropriate decision boundaries between the positive and negative samples. More particularly, the machine learning models (i.e., classifier) are trained to determine a likelihood of a user interaction data to be associated with a pre-existing user profile based on a distinguishing feature between the positive and negative samples.

Referring now to FIG. 4B, a simplified block diagram 420 representing evaluation process for probabilistically resolving user identity using machine learning models is illustrated in accordance with an example embodiment. In an embodiment, the machine learning models generated after training the supervised machine learning model (see, 414) are utilized to determine a likelihood of an anonymous interaction to be associated with a pre-existing user profile of a user during evaluation (see, 422).

When a deterministic match is not determined for an anonymous user interaction data (see, 430), the processor 306 tries to find a probabilistic match in the evaluation phase. As already explained, the processor 306 is configured to perform data pre-processing of the anonymous user interaction data to standardize and normalize event records in the anonymous user interaction data (see, 424). In one example, the anonymous user interaction data is parsed to extract tokens. Features are extracted from the anonymous user interaction data (see, 426) that vectorize the anonymous user interaction data. In one non-limiting example, the features are extracted from the tokens of the anonymous user interaction data.

The features are provided to a machine learning classifier that determines a likelihood of the anonymous user interaction data to be associated with a user who has a pre-existing user profile (see, 428). The machine learning classifier uses the machine learning models (see, 414) to predict if the anonymous user interaction data is associated with any candidate user profiles. The candidate user profiles are determined based on a predefined location. Specifically, the machine learning classifier determines one candidate user profile that has a matching probability score greater than a predefined threshold score. In other words, the processor 306 identifies the candidate user profile with user attributes that are similar to the anonymous user interaction data.

FIG. 5 is an example representation of an identity graph 500 associated with user profile of a user, in accordance with an example embodiment. The graph creation engine 324 may generate the identity graph 500 for the user profile of the user 102.

Specifically, the identity graph 500 of the user 102 is a database that stores all user attributes (i.e., identifiers) that correlate with the user 102. More specifically, the user attributes in the identity graph are all sourced from first-party data (i.e., online/offline sources associated with a business). The identity graph 500 includes user attributes such as, privacy compliant user information (e.g., customer identity), and usage characteristics (i.e., behavioral attributes) across multiple devices and multiple sessions. More specifically, the identity graph 500 stitches the data sourced from one or more sources associated with the business interface into one user profile. In one non-limiting example, the identity graph 500 collects and processes data such as but not limited to streaming data, batch data and data obtained by API calls to other system associated with the user 102 into one user profile as the identity graph 500. For example, information (i.e., the user interaction data) sourced from business interface software, CRM system, e-mail marketing tool and advertising platforms associated with the user 102 are stitched together in the identity graph 500.

The user attributes include but not limited to, registered username, contact numbers, e-mail identifiers, cookie data (e.g., browser information), IP addresses, geo-location, transaction information, interaction/event information, device characteristics (e.g., OS), behavioral information (e.g., temporal information) and the like.

The identity graph 500 represents a computer-based graph representation of the user attributes of the user 102. The user 102 is a root node and user attributes such as, Personal Identification Information (PII), e-mail identifiers, user devices, IP addresses, geo-location, transaction information from parent nodes 502a, 502b, 502c, 502d, 502e, 502f, respectively. The parent nodes 502a, 502b, 502c, 502d, 502e, 502f may terminate in leaf nodes or give rise to child nodes that may branch out further and be referred to as ‘parent nodes’ for child/leaf nodes. The leaf nodes of the identity graph 500 show data associated with different user attributes that are collected over time across multiple devices and sessions through which the user 102 accesses the business interface.

As shown in FIG. 5, the parent node 502a is associated with leaf nodes (504a, 504b) that show different usernames, passwords used by the user while accessing the business interface in different sessions with different devices. The leaf nodes (504a, 504b) may also include metadata, for example, user device/browser in which a specific username/password is used. The root node (i.e., the user 102) may be associated with e-mail identifiers shown by the leaf nodes 504c, 504d (i.e., abc1@abc.com, zabc@xyz.com). The user 102 may have accessed the business interface using user devices (shown by parent node 502c) such as, smartphone, laptop, tablet that are depicted by child nodes 504e, 504f, and 504g. Each of these child nodes 504e, 504f, and 504g form parent nodes for child nodes 504h, 504i, 504j, 504k, respectively that show different browsers (mobile application, Chrome®, Firefox®, Safari®) that the user 102 used on respective user devices (smartphone, laptop, tablet) for accessing the business interface.

The user 102 may have shown up on IP addresses (parent node 502d) for interacting with the business interface and sources associated with the business interface and are shown by leaf nodes 504l, 504m, 504n (IP1, IP2, IP3). The user attribute 502e (i.e., the geo-location) of the user 102 indicating locations from where he/she has accessed the business interface and allied services are shown by leaf nodes 504o, 504p (lat-lon1, lat-lon2) in terms of geographical co-ordinates of latitude-longitude position. The call logs, chat logs, purchase history (leaf nodes 504q, 504r, 504s) are shown by the parent node 502f indicating the transaction information associated with the user 102.

Additionally, each node (i.e., child/leaf node) includes metadata associated with the nodes, and/or information identifying relationships (such as, for example, usage attributes, transaction connections etc.) among the nodes. For example, the leaf node 5041 includes metadata indicating transactions performed while using the IP, associated browser and user devices.

In an embodiment, the graph creation engine 324 may update the identity graph 500 by adding nodes, adding edges, removing nodes, removing edges, adding additional metadata for existing nodes, removing metadata for existing nodes, and/or the like. In general, the structure of the identity graphs are flexible and allow linking and/or updating user attributes from a new or anonymous user interaction data based on matching (i.e., deterministic or probabilistic matching) with a pre-existing user profile.

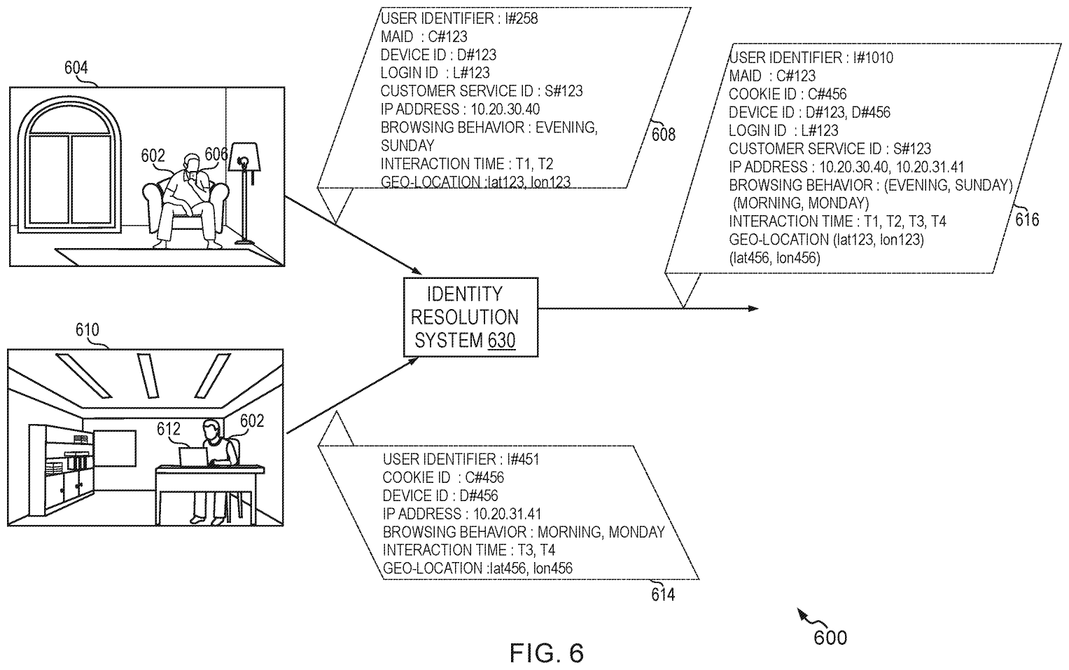

Referring now to FIG. 6, an environment 600 depicting an example of probabilistically resolving user identity is illustrated in accordance with an example embodiment.

The environment 600 depicts a lounge 604 in a house where a user 602 is relaxing over a weekend (i.e., Sunday) in the evening. The user 602 is associated with a mobile device 606 that is equipped with the business interface. The user 602 provides credentials for accessing a mobile application of the business via the mobile device 606 and he browses sports equipments (e.g., cricket bat, helmet) on the business interface for a session S1. Moreover, the user 602 converses with an online agent regarding sizes of the helmet. The user activity during the entire session S1 is tracked and aggregated as ‘user interaction data’ from online and offline sources associated with the business interface. For example, if the user 602 views 3 different cricket bats on the business interface, each product view on the business interface is tracked and MAIDs, IP address of the mobile device 606, geo-location of the mobile device 606, and usage behavior (i.e., transaction, chat logs, call logs) are aggregated.

The user interaction data (see, Table 608) includes user information such as, MAID, login ID and a customer service ID created during an interaction with the online agent and event attributes such as, IP address, browsing behavior, interaction time and geo-location of the user 602. As shown in FIG. 6, the user interaction data of the user 602 includes MAID (e.g., C #123), device ID (e.g., D #123), login ID (e.g., L #123), a customer service ID (e.g., S #123), IP address (e.g., 10.20.30.40), browsing behavior (e.g., evening, Sunday, cricket bat, and helmet), interaction time T1, T2 and geo-location of the mobile device 606 (lat123, lon123) for the session S1. It shall be noted that the browsing behavior, IP type and the interaction time are together referred to as ‘temporal data’.

The user interaction data aggregated from different sources is used to create a user profile for the user 602. Moreover, the user profile is provided a user identity (e.g., I #258) and stored in a database (e.g., the user profile database 116).

Subsequently, the next day (i.e., Monday) the user 602 accesses a web interface of the business via a laptop 612 in his office 610. However, the user 602 doesn't login or provide credentials but continues to browse cricket equipments anonymously during a session S2. The user interaction data (also referred to as ‘anonymous interaction’) collected during the session S2 is stored as a user profile with user identifier I #451. The user interaction data (see, Table 614) includes cookie ID (e.g., C #456), device ID (e.g., D #456), IP address (e.g., 10.20.31.41), browsing behavior (e.g., morning, Monday, cricket bat, and helmet), interaction time T3, T4 and geo-location of the laptop 612 (lat456, lon456) for the session S2.

In one example scenario, the identity resolution system 630 on receiving the user interaction data from session S2 processes the anonymous interaction and tries to probabilistically determine a pre-existing user profile that is similar to resolve user identity. The identity resolution system 630 is an example of the identity resolution system 112 shown and explained with reference to FIGS. 1 to 4A-4B.

When the user interaction data (i.e., anonymous interaction) is received from the laptop 612, the identity resolution system 630 tries to determine a deterministic match for the user interaction data based on user information. However, as the user 602 has not provided any personal information (i.e., anonymous access) for accessing the business interface during the session S2, a deterministic match is not possible for the user interaction data of the session S2. Alternatively, the identity resolution system 630 employs a probabilistic matching technique to predict likelihood of the user interaction data to be associated with at least one user profile within a geo-location boundary (i.e., the predefined location). More specifically, the identity resolution system 630 determines if the IP address (e.g., 10.20.31.41) is associated with another user profile sharing the same WiFi or associated with another IP address that is within the geo-location boundary (e.g., within 25-50 miles radius).

Additionally or alternatively, a behavioral/temporal similarity of the anonymous interaction with user profiles within the geo-location boundary is determined based on comparing temporal data. In general, the identity resolution system 630 analyzes the browsing behavior (e.g., morning, Monday, products/pages viewed), time pattern (i.e., t3, t4) along with the IP type of the user interaction data to determine temporal similarity between the user interaction data of session S2 and the user profiles in the geo-location boundary. For example, the identity resolution system 630 determines behavioral similarity such as, the user interaction data is from home/office, morning/afternoon/evening/night, and the browsing behavior.

The trained machine learning model determines likelihood of the user interaction data during session S2 to be associated with the user 602 (or the user profile I #258) who provided credentials (i.e., logged in) during the session S1. In other words, a matching probability score is determined with user profiles within the geo-location boundary based on the temporal similarity and similarity of IP addresses. The similarity measures are determined by the machine learning models that are trained to distinguish a user from another user. Specifically, the machine learning models are trained based on a probabilistic matching algorithm to determine decision boundary between two different users based on various similarity measures. After probabilistic matching, the identity resolution system 630 resolves that the online identities (i.e., the user profiles I #258 and I #451) are associated with the same user (i.e., the user 602) based on the matching probability score.

After probabilistically resolving the anonymous identity with the user 602, the identity resolution system 630 merges the user interaction data from the user profiles (I #258 and I #451). Thereafter, the identity resolution system 630 provides a unified user identifier (i.e., I #1010) for the merged user profiles that includes user interaction data from sessions S1 and S2 (see, Table 616).

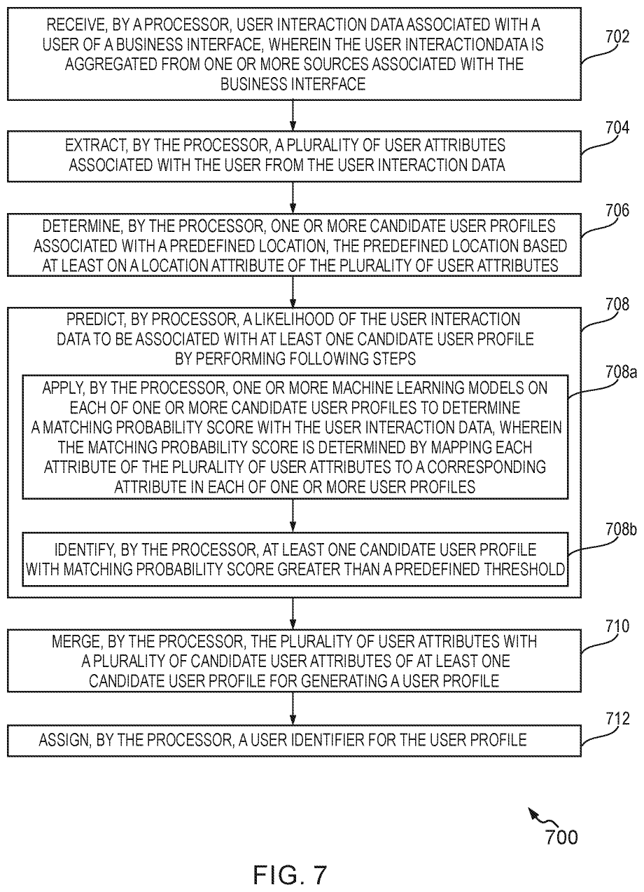

Referring now to FIG. 7, a flow diagram of a method 700 for probabilistically resolving user identity is illustrated in accordance with an example embodiment. The method 700 depicted in the flow diagram may be executed by, for example, the server system 110 or a processor embodied in the identity resolution system 112. Operations of the method 700, and combinations of operation in the method 700, may be implemented by, for example, hardware, firmware, a processor, circuitry and/or a different device associated with the execution of software that includes one or more computer program instructions. The method 700 starts at operation 702.

At operation 702, the method 700 includes receiving, by a processor, user interaction data associated with a user of a business interface, wherein the user interaction data is aggregated from one or more sources associated with the business interface. These sources refer to online and offline sources of the business such as but not limited to, business' websites, App, CRM, etc. The user interaction data is aggregated and obtained from sources includes streaming data, batch data and API supported system. More specifically, the user interaction data includes event records of a user interacting with the business interface during a session. For example, every event (e.g., product view, transaction, and search) on the business interface during the session is tracked and stored separately as event records.

At operation 704, the method 700 includes extracting, by the processor, a plurality of user attributes associated with the user from the user interaction data. In an embodiment, a flexible metadata based mapping is employed to identify data fields in the user interaction data. After mapping, the user attributes are extracted from the event records associated with the user interaction data. The extracted user attributes of a user are stored as a user profile with a user identifier. The user attributes include but not limited to, user information (e.g., name, age, gender, nationality, e-mail identifier, registered user name, contact number and the like) and event attributes (e.g., cookie data, IP address, geo-location of the user, browser specifications, device identifiers, usage characteristics such as, user behavior, cart information, URLs, and transaction information such as, payment history, call logs, chat logs and the like).

At operation 706, the method 700 includes determining, by the processor, one or more candidate user profiles associated with a predefined location among a plurality of user profiles. The predefined location is based at least on a location attribute of the plurality of user attributes.

At operation 708, the method 700 includes predicting, by the processor, a likelihood of the user interaction data to be associated with at least one candidate user profile by performing steps 708a-708b.

At operation 708a, the method 700 includes applying, by the processor, one or more machine learning models on each of one or more candidate user profiles to determine a matching probability score with the user interaction data. The matching probability score is determined by mapping each attribute of the plurality of user attributes to a corresponding attribute in each of one or more user profiles. In general, the machine learning models are trained to determine a distinction/decision boundary and determine if the user interaction data is related/associated with the candidate user profile based on matching features from the user interaction data and the candidate user profiles. More specifically, a temporal similarity and a device similarity are determined based on mapping temporal data (e.g., day of week, time of a day) and device identifiers (i.e., IP addresses) from the user interaction data with each of the candidate user profiles to calculate a matching probability score for each candidate user profile. In an example, the machine learning model is a supervised machine learning model such as, GBM, Gradient Boosted Trees, Random Forest, Logistic Regression or Deep Neural Networks.

At operation 708b, the method 700 includes identifying, by the processor, at least one candidate user profile associated with matching probability score greater than a predefined threshold.

At operation 710, the method 700 includes merging, by the processor, the plurality of user attributes from the user interaction data with a plurality of user attributes associated with at least one candidate user profile for generating a user profile.

At operation 712, the method 700 includes assigning, by the processor, a user identifier for the user profile.

The sequence of operations of the method 700 need not be necessarily executed in the same order as they are presented. Further, one or more operations may be grouped together and performed in form of a single step, or one operation may have several sub-steps that may be performed in parallel or in sequential manner.

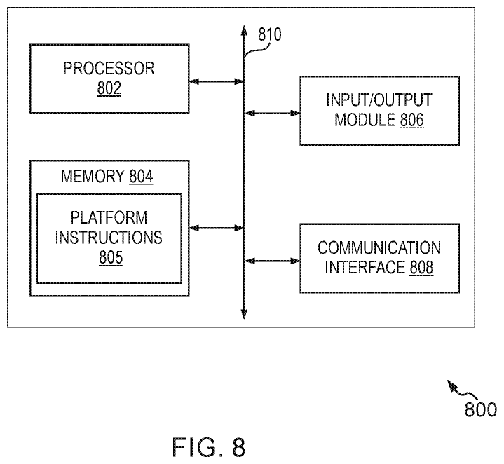

FIG. 8 is a block diagram of a server system 800, in accordance with an example embodiment. The server system 800 is configured to host and manage the business interface provided by a business. The business interface can be a web interface or a mobile interface. The server system 800 is an example of the server system 110 and/or can be embodied in the identity resolution system 112.

The server system 800 includes at least one processor such as a processor 802 and at least one memory such as a memory 804. The server system 800 also includes an input/output (I/O) module 806 and a communication interface 808.

Although the server system 800 is depicted to include only one processor 802, the server system 800 may include more number of processors therein. In an embodiment, the memory 804 is capable of storing platform instructions 805, where the platform instructions 805 are machine executable instructions associated with managing the business interface. Further, the processor 802 is capable of executing the stored platform instructions 805. In an embodiment, the processor 802 may be embodied as a multi-core processor, a single core processor, or a combination of one or more multi-core processors and one or more single core processors. For example, the processor 802 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 802 may be configured to execute hard-coded functionality. In an embodiment, the processor 802 is embodied as an executor of software instructions, wherein the instructions may specifically configure the processor 802 to perform the algorithms and/or operations described herein when the instructions are executed.

The memory 804 may be embodied as one or more volatile memory devices, one or more non-volatile memory devices, and/or a combination of one or more volatile memory devices and non-volatile memory devices. For example, the memory 804 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory including ROM and/or RAM (random access memory), etc.).

The input/output module 806 (hereinafter referred to as the ‘I/O module 806’) includes mechanisms configured to receive inputs from the user of the server system 800. The I/O module 806 is configured to be in communication with the processor 802 and the memory 804. Examples of the I/O module 806 include, but are not limited to, an input interface and/or an output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, the processor 802 may include I/O circuitry configured to control at least some functions of one or more elements of the I/O module 806, such as, for example, a speaker, a microphone, a display, and/or the like. The processor 802 and/or the I/O circuitry may be configured to control one or more functions of one or more elements of the I/O module 806 through computer program instructions, for example, software and/or firmware, stored on a memory, for example, the memory 804, and/or the like, accessible to the processor 802.

The communication interface 808 is configured to enable the server system 800 to communicate with other entities, such as for example, with consuming applications of user devices, either via internal circuitry or over various types of wired or wireless networks. To that effect, the communication interface 808 may include relevant application programming interfaces (APIs) to communicate with the consuming applications. In an example scenario, the communication interface 808 may send a request to the identity resolution system 300 for resolving anonymous online identities in the business interface to a user profile. In an embodiment, the communication interface 808 is configured to receive a plurality of user interaction data of a plurality of users from one or more sources. Specifically, the processor 802 aggregates data associated with a user received from one or more sources to create a user profile for the user. In an embodiment, the I/O module 806 may receive a request for the business interface from a user device (e.g., the user device 104a). The I/O module on receiving the request provides an instance of the business interface to the user device.

In an embodiment, various components of the server system 800, such as the processor 802, the memory 804, the I/O module 806 and the communication interface 808 are configured to communicate with each other via or through a centralized circuit system 810. The centralized circuit system 810 may be various devices configured to, among other things, provide or enable communication between the components (802-808) of the server system 800. In certain embodiments, the centralized circuit system 810 may be a central printed circuit board (PCB) such as a motherboard, a main board, a system board, or a logic board. The centralized circuit system 810 may also, or alternatively, include other printed circuit assemblies (PCAs) or communication channel media.

The server system 800 as illustrated and hereinafter described is merely illustrative of a system that could benefit from embodiments disclosed herein and, therefore, should not be taken to limit the scope of the invention. It is noted that the server system 800 may include fewer or more components than those depicted in FIG. 8.

In various embodiments, the processor 802 in conjunction with the memory 804 is configured to cause the server system 800 to perform various embodiments of probabilistically resolving user identities of anonymous interaction in the business interface, as described with reference to FIGS. 1 to 7.

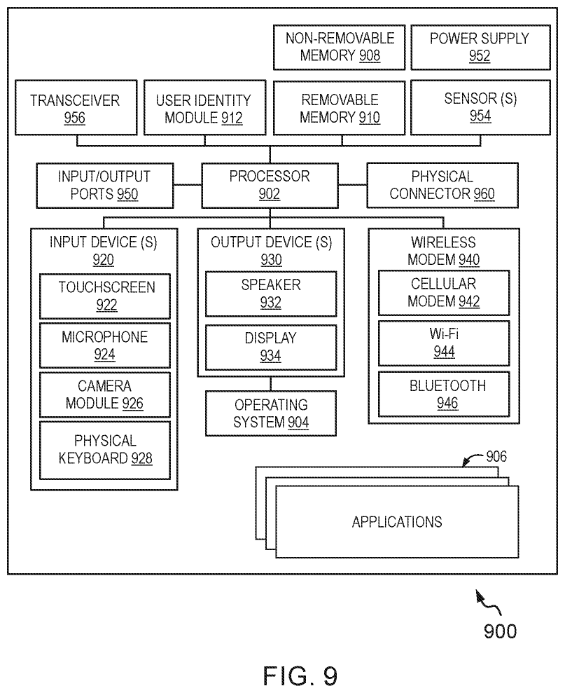

FIG. 9 shows a simplified block diagram of a user device 900, for example, a mobile phone or a desktop computer capable of implementing the various embodiments of the present disclosure. For example, the user device 900 may correspond to the user devices 104a, 104b and 104c associated with the user 102 who accesses the business interface using different devices (e.g., the user devices 104a, 104b, and 104c) at different sessions. The user device 900 is depicted to include one or more applications 906 (e.g., “business application”). The applications 906 can be an instance of an application downloaded from a third-party server.

It should be understood that the user device 900 as illustrated and hereinafter described is merely illustrative of one type of device and should not be taken to limit the scope of the embodiments. As such, it should be appreciated that at least some of the components described below in connection with the user device 900 may be optional and thus in an example embodiment may include more, less or different components than those described in connection with the example embodiment of the FIG. 9. As such, among other examples, the user device 900 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 900 includes a controller or a processor 902 (e.g., a signal processor, microprocessor, ASIC, or other control and processing logic circuitry) for performing such tasks as signal coding, data processing, image processing, input/output processing, power control, and/or other functions. An operating system 904 controls the allocation and usage of the components of the user device 900. In addition, the applications 906 may include common server performance monitoring applications or any other computing application.

The illustrated user device 900 includes one or more memory components, for example, a non-removable memory 908 and/or removable memory 910. The non-removable memory 908 and/or the removable memory 910 may be collectively known as a database in an embodiment. The non-removable memory 908 can include RAM, ROM, flash memory, a hard disk, or other well-known memory storage technologies. The removable memory 910 can include flash memory, smart cards, or a Subscriber Identity Module (SIM). The memory components can be used for storing data and/or code for running the operating system 904 and the applications 906. The user device 900 may further include a user identity module (UIM) 912. The UIM 912 may be a memory device having a processor built in. The UIM 912 may include, for example, a subscriber identity module (SIM), a universal integrated circuit card (UICC), a universal subscriber identity module (USIM), a removable user identity module (R-UIM), or any other smart card. The UIM 912 typically stores information elements related to a mobile subscriber. The UIM 912 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 900 can support one or more input devices 920 and one or more output devices 930. Examples of the input devices 920 may include, but are not limited to, a touch screen/a display screen 922 (e.g., capable of capturing finger tap inputs, finger gesture inputs, multi-finger tap inputs, multi-finger gesture inputs, or keystroke inputs from a virtual keyboard or keypad), a microphone 924 (e.g., capable of capturing voice input), a camera module 926 (e.g., capable of capturing still picture images and/or video images) and a physical keyboard 928. Examples of the output devices 930 may include, but are not limited to a speaker 932 and a display 934. Other possible output devices can include piezoelectric or other haptic output devices. Some devices can serve more than one input/output function. For example, the touch screen 922 and the display 934 can be combined into a single input/output device.

A wireless modem 940 can be coupled to one or more antennas (not shown in the FIG. 9) and can support two-way communications between the processor 902 and external devices, as is well understood in the art. The wireless modem 940 is shown generically and can include, for example, a cellular modem 942 for communicating at long range with the mobile communication network, a Wi-Fi compatible modem 944 for communicating at short range with an external Bluetooth-equipped device or a local wireless data network or router, and/or a Bluetooth-compatible modem 946. The wireless modem 940 is typically configured for communication with one or more cellular networks, such as a GSM network for data and voice communications within a single cellular network, between cellular networks, or between the user device 900 and a public switched telephone network (PSTN).

The user device 900 can further include one or more input/output ports 950, a power supply 952, one or more sensors 954, for example, an accelerometer, a gyroscope, a compass, or an infrared proximity sensor for detecting the orientation or motion of the user device 900 and biometric sensors for scanning biometric identity of an authorized user, a transceiver 956 (for wirelessly transmitting analog or digital signals) and/or a physical connector 960, which can be a USB port, IEEE 1294 (FireWire) port, and/or RS-232 port. The illustrated components are not required or all-inclusive, as any of the components shown can be deleted and other components can be added.

The disclosed method with reference to FIG. 7, or one or more operations of the identity resolution system 300 may be implemented using software including computer-executable instructions stored on one or more computer-readable media (e.g., non-transitory computer-readable media, such as one or more optical media discs, volatile memory components (e.g., DRAM or SRAM)), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the identity resolution system 300 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method for probabilistically resolving user identity, the computer-implemented method comprising:
receiving, by a processor, user interaction data associated with a user of a business interface, wherein the user interaction data is aggregated from one or more sources associated with the business interface;
extracting, by the processor, a plurality of user attributes associated with the user from the user interaction data;
determining, by the processor, one or more candidate user profiles associated with a predefined location among a plurality of user profiles, the predefined location based at least on a location attribute of the plurality of user attributes;
predicting, by the processor, a likelihood of the user interaction data to be associated with at least one candidate user profile by performing steps:
applying, by the processor, one or more machine learning models on each of the one or more candidate user profiles to determine a matching probability score with the user interaction data, wherein the matching probability score is determined by mapping each user attribute of the plurality of user attributes to a corresponding user attribute in each of the one or more candidate user profiles; and
identifying, by the processor, the at least one candidate user profile associated with matching probability score greater than a predefined threshold;
merging, by the processor, the plurality of user attributes from the user interaction data with a plurality of user attributes associated with the at least one candidate user profile for generating a user profile; and
assigning, by the processor, a user identifier for the user profile.

2. The computer-implemented method as claimed in claim 1, wherein applying the one or more machine learning models comprises:
calculating, by the processor, a temporal similarity measure between the user interaction data and each of the one or more candidate user profiles based at least in part on mapping of a temporal data of the user interaction data with a corresponding temporal data associated with each of the one or more candidate user profiles.

3. The computer-implemented method as claimed in claim 2, wherein applying the one or more machine learning models further comprises:
calculating, by the processor, a device similarity measure between the user interaction data and each of the one or more candidate user profiles based at least in part on mapping of a IP identifier of the user interaction data with an IP identifier associated with each of the one or more candidate user profiles.

4. The computer-implemented method as claimed in claim 3, wherein the matching probability score for a candidate user profile of the one or more candidate user profiles is determined based at least in part on the temporal similarity measure and the device similarity measure associated with the candidate user profile.

5. The computer-implemented method as claimed in claim 1, further comprising:
accessing, by the processor, an identity graph associated with the at least one candidate user profile from one or more databases;
updating, by the processor, the identity graph associated with the at least one candidate user profile based at least in part on the plurality of user attributes associated with the user interaction data; and
storing, by the processor, the identity graph in the one or more databases.

6. The computer-implemented method as claimed in claim 1, further comprising:
matching, by the processor, deterministically at least a set of user attributes of the plurality of user attributes associated with the user interaction data of the user with corresponding attributes of at least one user profile of the plurality of user profiles based at least in part on a plurality of identity graphs, wherein each identity graph is associated with a user profile of the plurality of user profiles.

7. The computer-implemented method as claimed in claim 6, further comprising:
accessing, by the processor, a positive sample comprising one or more user interaction data of the user accessing the business interface from one or more user devices at different sessions, wherein the one or more user interaction data associated with the user are matched based on a deterministic matching of the one or more user profiles;
accessing, by the processor, a negative sample, the negative sample comprising one or more user interaction data randomly selected from remaining user profiles of the plurality of user profiles;
extracting, by the processor, a first set of features from the positive samples and a second set of features from the negative samples; and
generating, by the processor, the one or more machine learning models based at least in part on the first set of features and the second set of features, wherein the one or more machine learning models learn to differentiate between the first set of features and the second set of features.

8. The computer-implemented method as claimed in claim 1, wherein the plurality of user attributes is extracted based at least in part on a flexible metadata based mapping.

9. An identity resolution system for probabilistically resolving user identities, the identity resolution system comprising:
a communication interface;
a memory comprising executable instructions; and
a processor communicably coupled to the communication interface, the processor configured to execute the executable instructions to cause the identity resolution system to at least:
receive user interaction data associated with a user of a business interface, wherein the user interaction data is aggregated from one or more sources associated with the business interface;
extract a plurality of user attributes associated with the user from the user interaction data;
determine one or more candidate user profiles associated with a predefined location among a plurality of user profiles, the predefined location based at least on a location attribute of the plurality of user attributes;
predict a likelihood of the user interaction data to be associated with at least one candidate user profile by performing steps:
applying one or more machine learning models on each of the one or more candidate user profiles to determine a matching probability score with the user interaction data, wherein the matching probability score is determined by mapping each attribute of the plurality of user attributes to a corresponding attribute in each of the one or more candidate user profiles; and
identifying the at least one candidate user profile associated with the matching probability score greater than a predefined threshold;
merge the plurality of user attributes from the user interaction data with a plurality of user attributes associated with the at least one candidate user profile for generating a user profile; and
assign a user identifier for the user profile. The identity resolution system as claimed in claim 9, wherein for applying the one or more machine learning models, the identity resolution system is caused to at least:
calculate a temporal similarity measure between the user interaction data and each of the one or more candidate user profiles based at least in part on mapping of a temporal data of the user interaction data with a corresponding temporal data associated with each of the candidate user profiles.

10. The identity resolution system as claimed in claim 9, wherein for applying the one or more machine learning models, the identity resolution system is caused to at least:
calculate a temporal similarity measure between the user interaction data and each of the one or more candidate user profiles based at least in part on mapping of a temporal data of the user interaction data with a corresponding temporal data associated with each of the candidate user profiles.

11. The identity resolution system as claimed in claim 10, wherein for applying the one or more machine learning models, the identity resolution system is further caused to at least:
calculate a device similarity measure between the user interaction data and each of the one or more candidate user profiles based at least in part on mapping of an IP identifier of the user interaction data with an IP identifier associated with each of the one or more candidate user profiles.

12. The identity resolution system as claimed in claim 11, wherein the matching probability score for a candidate user profile of the one or more candidate user profiles is determined based at least in part on the temporal similarity measure and the device similarity measure associated with the candidate user profile.

13. The identity resolution system as claimed in claim 11, wherein the identity resolution system is further caused to at least:
access an identity graph associated with the at least one candidate user profile from one or more databases;
update the identity graph associated with the at least one candidate user profile based at least in part on the plurality of user attributes associated with the user interaction data; and
store the identity graph in the one or more databases.

14. The identity resolution system as claimed in claim 9, wherein the identity resolution system is further caused to at least:
match deterministically at least a set of user attributes of the plurality of user attributes associated with the user interaction data of the user with corresponding user attributes of at least one user profile of the plurality of user profiles based at least in part on a plurality of identity graphs, wherein each identity graph is associated with a user profile of the plurality of user profiles.

15. The identity resolution system as claimed in claim 14, wherein the identity resolution system is further caused to at least:
train a supervised machine learning model based on a plurality of user interaction data accessed during a predefined interval by performing steps:
accessing a positive sample comprising one or more user interaction data of the user accessing the business interface from one or more user devices at different sessions, wherein the one or more user interaction data associated with different user profiles are deterministically matched to form the user profile;
accessing a negative sample, the negative sample comprising one or more user interaction data randomly selected from remaining user profiles of the plurality of user profiles;
extracting a first set of features from the positive samples and a second set of features from the negative samples; and
generating the one or more machine learning models based at least in part on the first set of features and the second set of features, wherein the one or more machine learning models learn to differentiate between the first set of features and the second set of features.

16. The identity resolution system as claimed in claim 9, wherein the plurality of user attributes is extracted based at least in part on a flexible metadata based mapping.

17. A computer-implemented method for probabilistically resolving user identities, the computer-implemented method comprising:
receiving, by a processor, user interaction data associated with a user of a business interface, wherein the user interaction data is aggregated from one or more sources associated with the business interface;
extracting, by the processor, a plurality of user attributes associated with the user from the user interaction data based on a flexible metadata based mapping;
determining, by the processor, one or more candidate user profiles associated with a predefined location among a plurality of user profiles, the predefined location based at least on a location attribute of the plurality of user attributes;
predicting, by the processor, a likelihood of the user interaction data to be associated with at least one candidate user profile by performing steps:
applying, by the processor, one or more machine learning models on each of the one or more candidate user profiles to determine a matching probability score with the user interaction data, wherein the matching probability score is determined by mapping each user attribute of the plurality of user attributes to a corresponding user attribute in each of the one or more candidate user profiles; and
identifying, by the processor, the at least one candidate user profile associated with the matching probability score greater than a predefined threshold;
merging, by the processor, the plurality of user attributes from the user interaction data with a plurality of user attributes associated with the at least one candidate user profile for generating a user profile;
creating, by the processor, an identity graph for the user profile based at least in part on the plurality of user attributes from the user interaction data and the plurality of user attributes associated with the at least one candidate user profile; and
assigning, by the processor, a user identifier for the user profile.

18. The computer-implemented method as claimed in claim 17, wherein applying the one or more machine learning models comprises:
calculating, by the processor, a temporal similarity measure between the user interaction data and each of the one or more candidate user profiles based at least in part on mapping of a temporal data of the user interaction data with a corresponding temporal data associated with each of the one or more candidate user profiles.

19. The computer-implemented method as claimed in claim 18, wherein applying the one or more machine learning models further comprises:
calculating, by the processor, a device similarity measure between the user interaction data and each of the one or more candidate user profiles based at least in part on mapping of an IP identifier of the user interaction data with an IP identifier associated with each of the one or more candidate user profiles.

20. The computer-implemented method as claimed in claim 19, wherein the matching probability score for a candidate user profile of the one or more candidate user profiles is determined based at least in part on the temporal similarity measure and the device similarity measure associated with the candidate user profile.
